(19) United States
(12) Patent Application Publication
(10) Pub. No.: US 2007/0003262 A1
(43) Pub. Date: Jan. 4, 2007

(54) Camera system equipped with camera shake correction function

(76) Inventor: Kazutoshi Shiratori, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/472,191

(22) Filed: Jun. 21, 2006

(30) Foreign Application Priority Data
Jul. 1, 2005 (JP) 2005-194072

(51) Int. Cl. G03B 17/00

(52) U.S. Cl. 396/55

(57) ABSTRACT

A camera system according to the present invention comprises: a transmission circuit comprised by the camera body and which is a circuit for transmitting control information used for controlling the photography lens; a reception circuit comprised by the camera body and which is a circuit for receiving the control information; a camera shake correction unit comprised by the camera body and which is the unit for compensating a shake generated in a image on a photographed surface; and a camera shake correction control unit for changing an operation condition of the camera shake correction unit when the reception circuit receives prescribed control information for issuing a setup instruction for a photographing preparation in order to provide the camera system enabling a control of a stabilization function comprised by a photography lens without complicating a communication between the photography lens and a camera body.

### CROSS-REFERENCE TO RELATED APPLICATIONS

This application claims benefit of Japanese Patent Application No. 2005-194072 filed on Jul. 1, 2005, the contents of which are incorporated by this reference.

### BACKGROUND OF THE INVENTION

1. Field of the Invention

The present invention relates to a camera system enabling a detachable attachment of a photography lens with a camera body, and in particular to a camera system enabling an operation of a camera shake correction by using apart or the entirety of a camera shake correction function which is equipped on the photography lens or the camera body.

2. Description of the Related Art

In recent years, many of camera systems equipped with a camera shake correction function have been proposed for the purpose of improving operability. For a camera system allowing a detachable attachment of a photography lens (sometimes “photo lens” hereinafter) with a camera body, a camera system equipped with a camera shake correction function which is operable independently in not only a camera body but also a photo lens has been proposed. Accordingly, camera systems of various configurations, such as one having a camera shake correction function in both of the photo lens and camera body, one having a camera shake correction function in either of the photo lens or camera body, et cetera, are being used depending on the usage.

There have been problems associated with a diversification of functions of a photo lens and a camera body as described above, such as complex communication between a photo lens and the camera body.

A Laid-Open Japanese Patent Application Publication No. 08-114825 has accordingly disclosed a photo lens, in the one having a camera shake correction function, comprising a movement detection apparatus for detecting a movement of a focusing member within the aforementioned photo lens and operating the camera shake correction function if the movement detection apparatus detects a movement of the focusing member.

The method noted in the Laid-Open Japanese Patent Application Publication No. 08-114825, however, has not eliminated the problems of the camera shake correction function not functioning if a focus does not move, et cetera. Besides, another new function needs to be added in order to operate the camera shake correction function even if the focusing member does not move and therefore a problem such as a complex communication between a photo lens and the camera body is not eliminated.

### SUMMARY OF THE INVENTION

According to the present invention, in the lens changeable camera system in which a photography lens and a camera body are connected detachably with each other, the camera system comprises a transmission circuit comprised by the camera body and which is a circuit for transmitting control information used for controlling the photography lens from the camera body thereto; a reception circuit comprised by the photography lens and which is a circuit for receiving the control information transmitted from the transmission circuit; a camera-shake correction unit comprised by the photography lens and which is the unit for compensating a shake generated in a image on a photographed surface by a shake of the camera system at the time of photographing; and a camera shake correction control unit for changing an operation condition of the camera shake correction unit when the reception circuit receives prescribed control information for issuing a setup instruction for a photographing preparation.

### BRIEF DESCRIPTION OF THE DRAWINGS

FIG. 1 is a diagram showing an overall configuration of a camera system according to a first embodiment;

FIG. 2 is a flow chart showing a setup process of an anti-shake (“a stabilization” hereinafter) mode according to the first embodiment;

FIG. 3A is a flow chart showing a photographing operation of a camera system according to the first embodiment;

FIG. 3B is a flow chart showing a photographing operation of a camera system according to the first embodiment;

FIG. 4 is a diagram describing a stabilization operation operated by a stabilization selection process according to the first embodiment;

FIG. 5 is a flow chart showing a detailed process of a stabilization selection process in the step S308 shown in FIG. 3A;

FIG. 6 is a diagram exemplifying a configuration of a camera system having an equivalent stabilization function to a camera system according to the first embodiment;

FIG. 7 is a diagram exemplifying a configuration of an L-0C type photo lens shown in FIG. 6;

FIG. 8 is a diagram exemplifying a configuration of an L-S0 type photo lens shown in FIG. 6;

FIG. 9 is a diagram exemplifying a configuration of an L-00 type photo lens shown in FIG. 6;

FIG. 10 is a diagram exemplifying a configuration of a B-0C type camera body shown in FIG. 6;

FIG. 11 is a diagram exemplifying a configuration of a B-S0 type camera body shown in FIG. 6;

FIG. 12 is a diagram exemplifying a configuration of a B-00 type camera body shown in FIG. 6;

FIG. 13 is a diagram exemplifying a configuration of a camera system having an equivalent stabilization function to a camera system according to the first embodiment;

FIG. 14 is a diagram exemplifying a configuration of an LC-SC type converter lens shown in FIG. 13;

FIG. 15 is a diagram exemplifying a configuration of an LC-0C type converter lens shown in FIG. 13;

FIG. 16 is a diagram exemplifying a configuration of an LC-S0 type converter lens shown in FIG. 13;

FIG. 17 is a diagram exemplifying a configuration of an LC-00 type converter lens shown in FIG. 13;

FIG. 18A is a flow chart showing a photography operation of a camera system according to a second embodiment;

FIG. 18B is a flow chart showing a photography operation of a camera system according to the second embodiment;

FIG. 18C is a flow chart showing a photography operation of a camera system according to the second embodiment;

FIG. 19 is a diagram for describing a stabilization operation operated by a stabilization selection process according to the second embodiment;

FIG. 20 is a diagram showing an overall configuration of a camera system according to a third embodiment;

FIG. 21 is a diagram showing a concrete example of a stabilization display according to the third embodiment;

FIG. 22 is a flow chart exemplifying a display process of a stabilization display shown in FIG. 21;

FIG. 23 exemplifies state transitions of a stabilization display according to the third embodiment;

FIG. 24 is a diagram exemplifying the case of displaying, in a liquid crystal display (LCD) monitor, a stabilization display according to the third embodiment;

FIG. 25 is a diagram exemplifying the case of displaying, in a control panel, a stabilization display according to the third embodiment;

FIG. 26 is a diagram exemplifying the case of displaying, in a finder, a stabilization display according to the third embodiment; and

FIG. 27 is a diagram describing a communication procedure of a camera system according to the first embodiment of the present invention.

### DESCRIPTION OF THE PREFERRED EMBODIMENTS

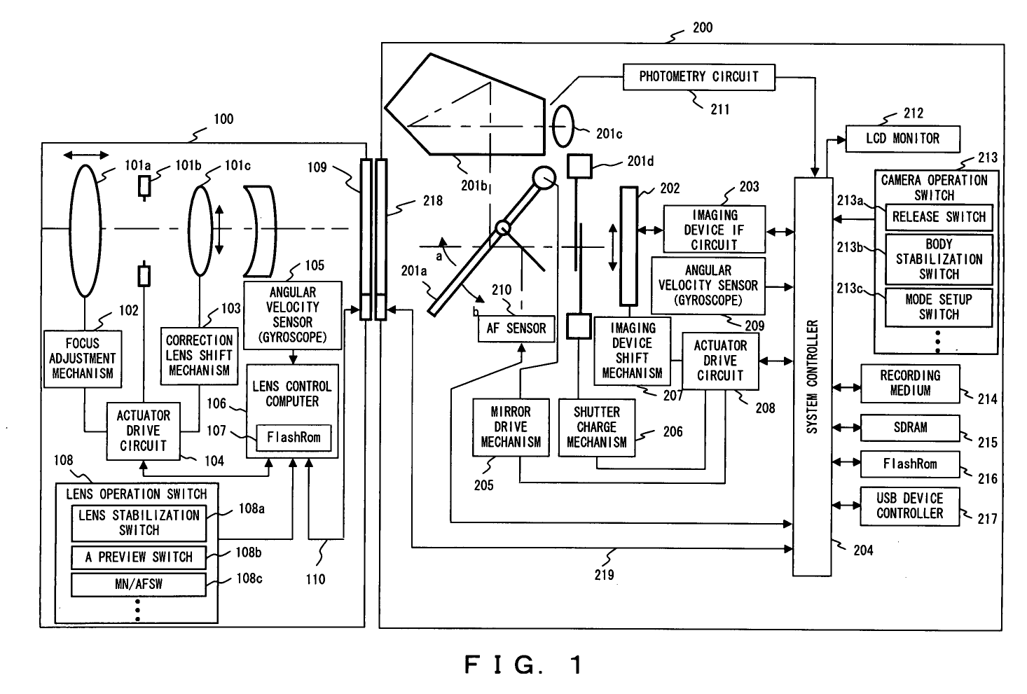

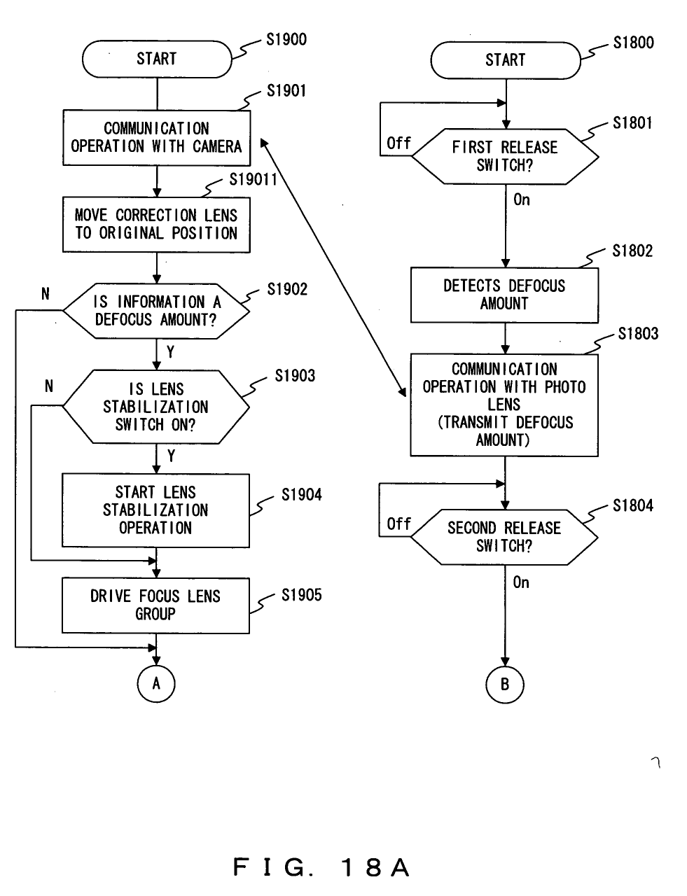

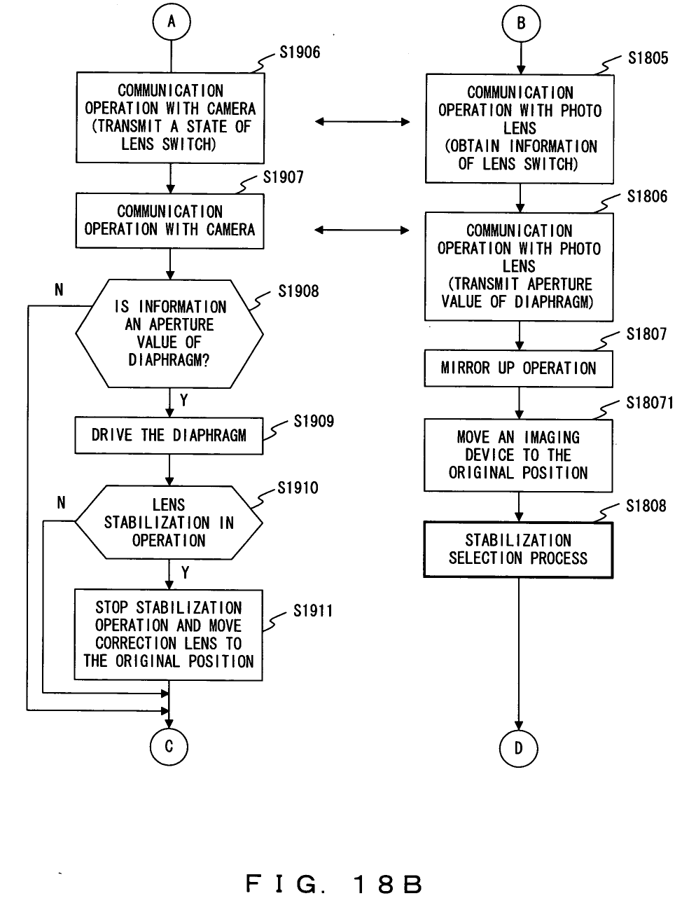

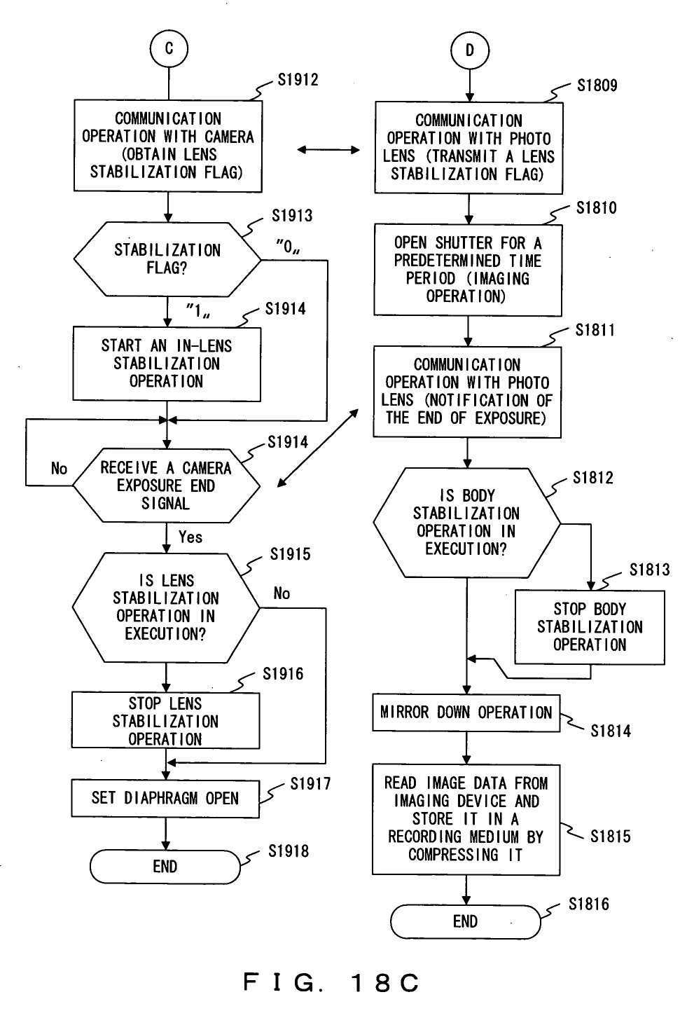

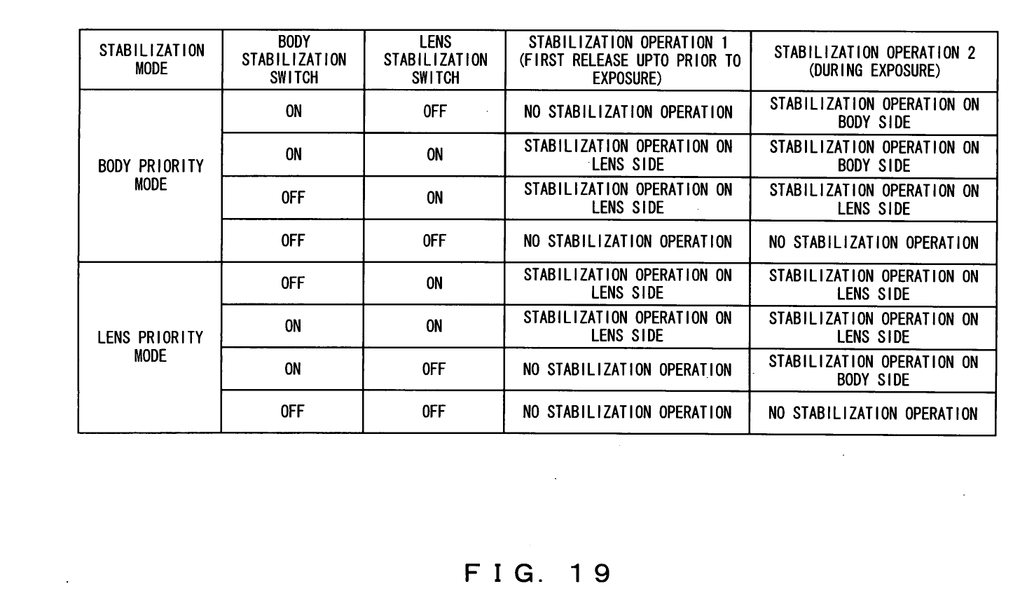

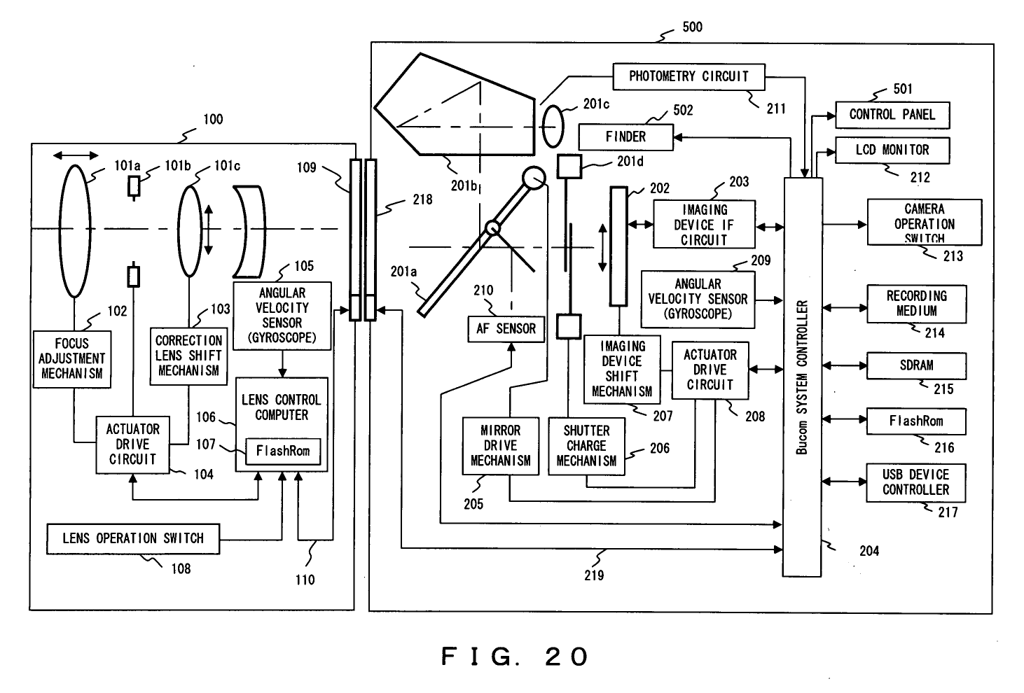

The following is a detailed description of the preferred embodiments of the present invention by referring to FIGS. 1 through 27, with a description of the first embodiment based on FIGS. 1 through 17, that of the second embodiment based on FIGS. 18A through 19 and that of the third embodiment based on FIGS. 20 through 26.

### (1) First Embodiment

FIG. 1 is a diagram showing an overall configuration of a camera system according to the first embodiment.

A camera system shown by FIG. 1 comprises a photography lens (“photo lens” hereinafter) 100 and a camera body 200 which are mutually detachably connected with each other.

The photo lens 100 comprises an optical system which includes at least a focus lens 101a for adjusting focus, a diaphragm 101b for limiting an incident light amount and a correction lens 101c for changing an optical axis of the incident light.

Also, photo lens 100 comprises a focus adjustment mechanism 102 for performing a focus adjustment by moving the focus lens 101a in the optical axis direction, a correction lens shift mechanism 103 for shifting the correction lens 101c on a plane perpendicular to the optical axis or tilting the correction lens 101c, an actuator drive circuit 104 for driving the diaphragm 101b, focus adjustment mechanism 102 and correction lens shift mechanism 103, an angular velocity sensor 105 for detecting a vibration (i.e., camera shake) of the photo lens 100, a lens control computer 106 for performing a control of the photo lens 100 according to an instruction from the camera body 200 and also an anti-shake (“stabilization” hereinafter) operation, Flash ROM 107 storing a program for operating the lens control computer 106 and parameters such as a focal distance of the lens, and a lens operation switch 108 which is a group of switches for setting up the aforementioned photo lens 100.

In the configuration described above, the lens operation switch 108 comprises at least a lens stabilization switch 108a for setting up an enablement or disablement of a camera shake compensation function (i.e., an anti-shake function which is termed as “stabilization function” hereinafter) of the photo lens 100, a preview switch 108b for operating the diaphragm 101b independent of a photographing operation and a manual/auto-focus (MN/AF) switch 108c for switching over between manual focus and automatic focus.

The lens control computer 106 drives the actuator drive circuit 104 according to an instruction from the camera body 200, thereby operating the diaphragm 101b, focus adjustment mechanism 102 or correction lens shift mechanism 103.

The lens control computer 106 calculates a camera shake amount by applying an integration process to an angular velocity measured by the angular velocity sensor 105, followed by driving the actuator drive circuit 104 and correction lens shift mechanism 103 so as to correct the aforementioned camera shake amount. As a result, the correction lens 101c changes positions and the optical axis accordingly changes positions so as to correct the camera shake amount.

Meanwhile, the camera body 200 comprises an optical system which includes a quick return mirror 201a for changing over light paths of an incident light from the photo lens 100, a penta prism 201b for sending a reflecting light from the quick return mirror 201a to an eye piece lens 201c, an eye piece lens 201c and a shutter 201d for controlling an exposure for an imaging device 202.

The camera body 200 comprises an imaging device 202 for converting an image of an object, which is obtained by forming an image of incident light exposed by way of the shutter 201d, into an electric signal, an imaging device interface (IF) circuit 203 for generating a digital signal from the electric signal obtained by the imaging device 202 and a system controller 204 for generating image data from the digital signal generated by the imaging device IF circuit 203 and also controlling the entirety of the camera system.

The camera body 200 also comprises a mirror drive mechanism 205 for driving the quick return mirror 201a, a shutter charge mechanism 206 for opening and closing the shutter 201d, an imaging device shift mechanism 207 for shifting the imaging device 202 on a plane perpendicular to the optical axis of the incident light, an actuator drive circuit 208 for driving the mirror drive mechanism 205, shutter charge mechanism 206 and imaging device shift mechanism 207, an angular velocity sensor 209 for detecting a vibration of the camera body 200 (i.e., a camera shake), an auto focus (AF) sensor 210 for measuring a distance to an object and a photometry circuit 211 for measuring an intensity of the light.

The camera body 200 further comprises an LCD monitor 212 for displaying an image of an object obtained by way of the imaging device 202 and imaging device IF circuit 203 and a state of the camera system, et cetera, a camera operation switch 213 which is a group of various switches for setting up an enablement or disablement of the stabilization function and setting up a condition of the camera system, a recording medium 2l4 for recording image data generated by the system controller 204, an SDRAM 215 for storing data, et cetera, used by a program operating within the system controller 204, a Flash ROM 216 for storing a program operating within the system controller 204 and parameters such as conditions, et cetera, of the camera system, and a Universal Serial Bus (USB) device controller 217 for connecting the camera body 200 and an external units such as an information processing device.

In the configuration described above, the camera operation switch 213 comprises at least a two-step press release switch (i.e., a first release switch for instructing a photography preparatory operation start and a second release switch for instructing a photography operation start) 213a for starting a photography operation, a body stabilization switch 213b for setting an enablement or disablement of the stabilization function of the camera body 200, a mode setup switch 213c for setting an operation condition of the camera system. Note that the body stabilization switch 213b and mode setup switch 213c may be implemented by using an LCD monitor 213 equipped with a touch sensor function.

Here, the mode setup switch 213c designates a priority order between a setup of the lens stabilization switch 108a comprised by the lens operation switch 108 and that of the body stabilization switch 213b comprised by the camera operation switch 213. It is possible to select as to which of the stabilization functions to operate in priority if both of the photo lens 100 and camera body 200 are equipped with the respective stabilization functions, for instance.

The following description defines a mode for operating the setup of the lens stabilization switch 108a in priority as “lens priority mode” and that for operating the setup of the body stabilization switch 213b in priority as “body priority mode”. It also calls “stabilization mode” generically for both of the lens priority mode and body priority mode.

The photo lens 100 and camera body 200 are detachably connected by means of a lens (L) mount 109 and a body (B) mount 218, thereby connecting the optical system comprised by the photo lens 100 to the one comprised by the camera body 200.

A lens-side communication line 110 is connected to a body-side communication line 219 by way of the L mount 109 and B mount 218, enabling communications between the lens control computer 106 and system controller 204.

In the configuration described above, a vibration gyroscope which is an angular velocity sensor utilizing a Coriolis force is used for each of the angular velocity sensors 105 and 209 according to the present embodiment.

The system controller 204 drives the actuator drive circuit 208 according to an output of the camera operation switch 213, thereby making the mirror drive mechanism 205 and shutter charge mechanism 206 operate.

The system controller 204 also calculates an amount of a camera shake by performing an integration process for an angular velocity measured by the angular velocity sensor 209 and drives the actuator drive circuit 208 so as to correct the aforementioned amount of the camera shake for making the imaging device shift mechanism 207 operate, thus resulting in preventing a degradation of an image which is formed on the imaging device 202 due to a camera shake.

The system controller 204 also calculates an amount of focus adjustment according to an output of the AF sensor 210 and issues an instruction to the photo lens 100 (i.e., the lens control computer 106). It also calculates an amount of a diaphragm adjustment according to an output of the photometry circuit 211 and issues an instruction to the photo lens 100 (i.e., the lens control computer 106).

Note that the configuration enables a mutually independent operation of the stabilization functions for the above described photo lens 100 and camera body 200, respectively. That is, the photo lens 100 is enabled for a stabilization function only in the aforementioned photo lens 100, thereby making it possible to configure a camera system enabled for stabilization regardless of whether the mounted camera body 200 has a stabilization function.

Likewise, the camera body 200 is configured to enable a stabilization operation only by the camera body 200, and therefore it is possible to configure a stabilization-enabled camera system regardless of whether the mounting photo lens 100 has a stabilization function.

Here, the stabilization function of the photo lens 100 is mainly implemented by the correction lens 101c, correction lens shift mechanism 103, actuator drive circuit 104, angular velocity sensor 105 and lens control computer 106. That is, the camera shake correction means of the photo lens 100 is constituted by the correction lens 101c, correction lens shift mechanism 103, actuator drive circuit 104, angular velocity sensor 105 and lens control computer 106.

Meanwhile, the stabilization function of the camera body 200 is mainly implemented by the imaging device 202, system controller 204, imaging device shift mechanism 207, actuator drive circuit 208 and angular velocity sensor 209. That is, the camera shake correction means of the camera body 200 is constituted by the imaging device 202, system controller 204, imaging device shift mechanism 207, actuator drive circuit 208 and angular velocity sensor 209.

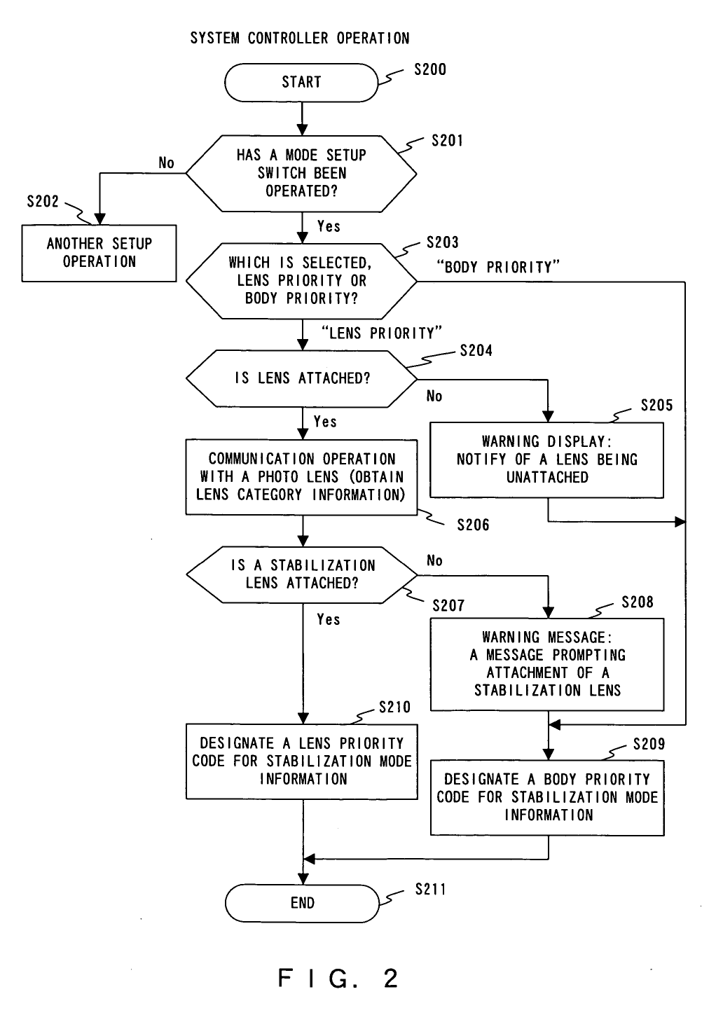

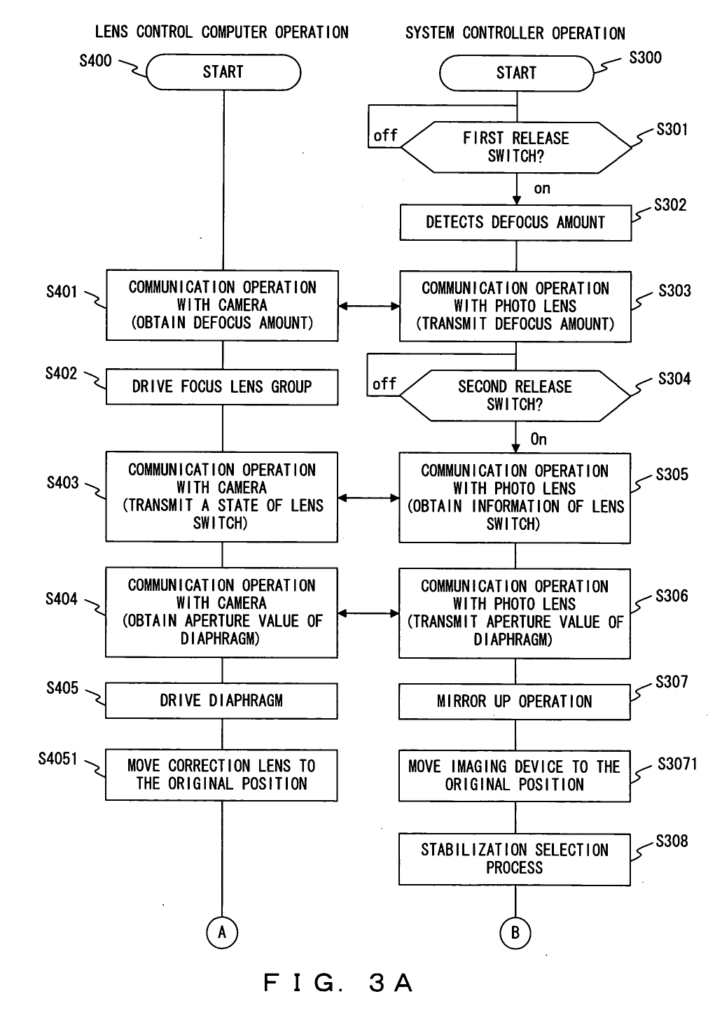

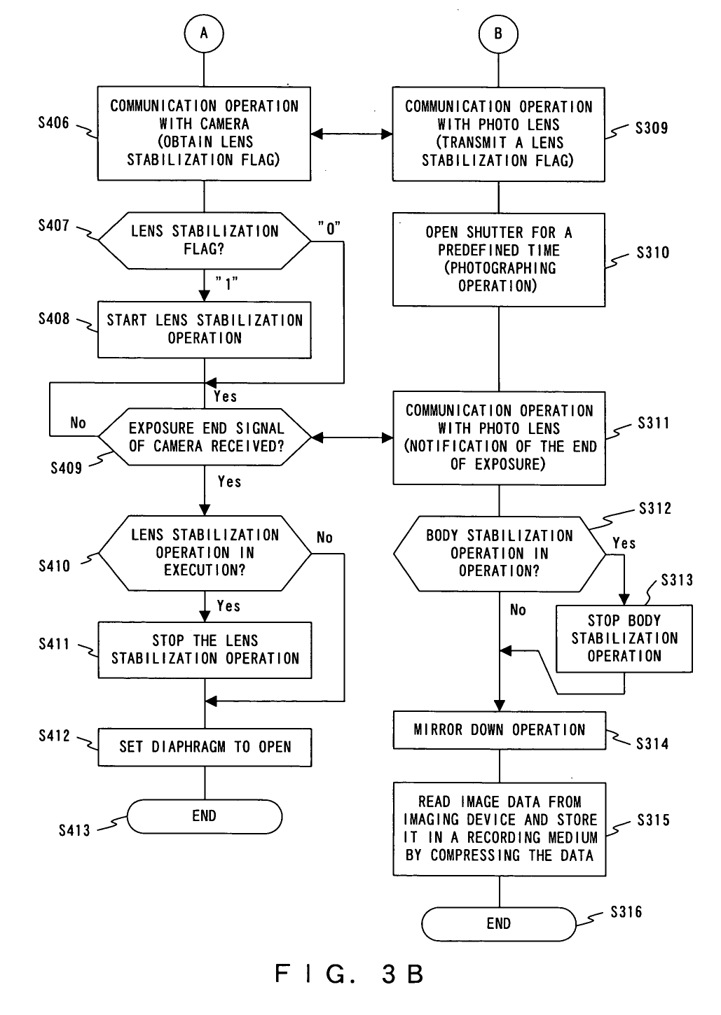

The next description, based on FIG. 2, is of the process for setting a stabilization mode by the mode setup switch 213c in the camera system configured as described above. And it is followed by a description of the process of operating a stabilization function according to the aforementioned stabilization mode, based on FIGS. 3A through 5.

FIG. 2 is a flow chart showing a setup process of a stabilization mode.

As the camera operation switch 213 is operated, an interrupt signal is input to the system controller 204, for example. Then, a micro processor unit (MPU) comprised by the system controller 204 executes a program stored in a prescribed address within the Flash Rom 216 in response to the interrupt signal, thereby starting a setup process such as a stabilization mode, et cetera (step S200) (simply a lá “S200” hereinafter).

Note that while the process described in the following is implemented by the MPU comprised by the system controller 204 executing instructions described in a prescribed program, the description of the present specification handles the system controller 204 as the subject for the purpose of simplification.

In the S201, the system controller 204 discerns whether or not the mode setup switch 213c is operated. If a camera operation switch 213 other than the mode setup switch 213c is operated, it shifts the process to the S202 and starts a process according to the respective camera operation switches 213.

If the mode setup switch 213c is operated, the system controller 204 shifts the process to the S203 and obtains a setup of the mode setup switch 213c to discern as to which of the lens priority mode and the body priority mode is set by the aforementioned setup.

If the aforementioned setup designates the lens priority mode, it shifts the process to the S204, while if the setup designates the body priority mode, it shifts the process to the S209.

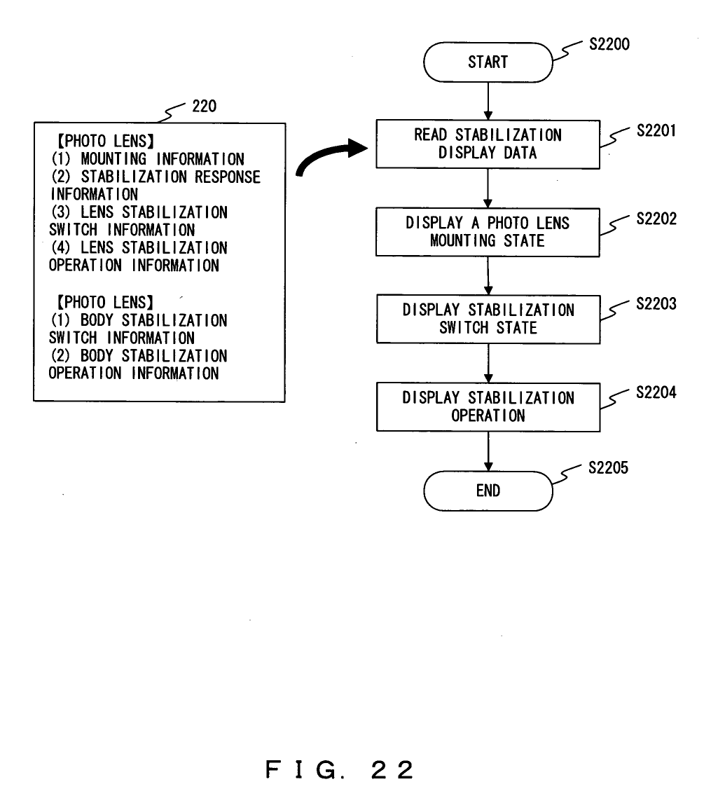

In the S204, the system controller 204 discerns whether or not the photo lens 100 is mounted and stores the aforementioned judgment result in mount information of data for a state display (that is called “stabilization display data 220” hereinafter) which is stored in the Flash Rom 216. Incidentally, the stabilization display data 220 is described in detail associated with FIG. 22.

Then, if the photo lens 100 is not mounted, it shifts the process to the S205 and displays in the LCD monitor, et cetera, the fact of a photo lens 100 being not mounted (thereby having a user recognize that a photo lens 100 is not mounted).

In this event, whether or not a photo lens 100 is mounted can only be discerned for example by conducting a communication between the system controller 204 and lens control computer 106 and by a presence or absence of the response to the communication. That is, the photo lens 100 can only be judged as being not mounted if a response is not provided from the lens control computer 106 for a predefined length of time.

If the photo lens 100 is judged to be mounted in the S204, the system controller 204 shifts the process to the S206, in which it carries out a communication operation with the lens control computer 106 for obtaining lens category information and stores, in stabilization response information of the stabilization display data 220, as to whether or not the presently mounted photo lens 100 comprises a stabilization function.

The system controller 204 requests the lens control computer 106 for lens category information, for instance. Meanwhile, the lens control computer 106 accordingly reads the lens category information stored in a prescribed address of the Flash ROM 107 and transmits it to the system controller 204 which then discerns whether or not the presently mounted photo lens 100 comprises a stabilization function and stores the aforementioned discernment result in the stabilization response information of the stabilization display data 220.

Note that the lens category information includes at least a category of the presently mounted photo lens 100, e.g., the information for identifying whether or not it is a lens having a stabilization function (simply “stabilization lens” hereinafter), and is stored in a prescribed address of the Flash ROM 107 in advance.

Having obtained the lens category information of the presently mounted photo lens 100 in the S206, the system controller 204 shifts the process to the S207 and discerns whether or not the presently mounted photo lens 100 is a stabilization lens from the aforementioned lens category information.

If the presently mounted photo lens 100 is not a stabilization lens, it shifts the process to the S208 and displays a warning message such as “the attached photo lens is not a stabilization lens. Please attach a stabilization lens”, in the LCD monitor 212, et cetera.

Having displayed the warning message in the LCD monitor 212, et cetera, in the S208, the system controller 204 shifts the process to the S209, followed by designating the body priority mode for stabilization mode stored in a prescribed address of the Flash Rom 216 and ending the process (S211).

Comparably, if the presently mounted photo lens 100 is judged to be a stabilization lens in the S207, it shifts the process to the S210. Then the system controller 204 designates the lens priority mode for the stabilization mode information and ends the process (S211).

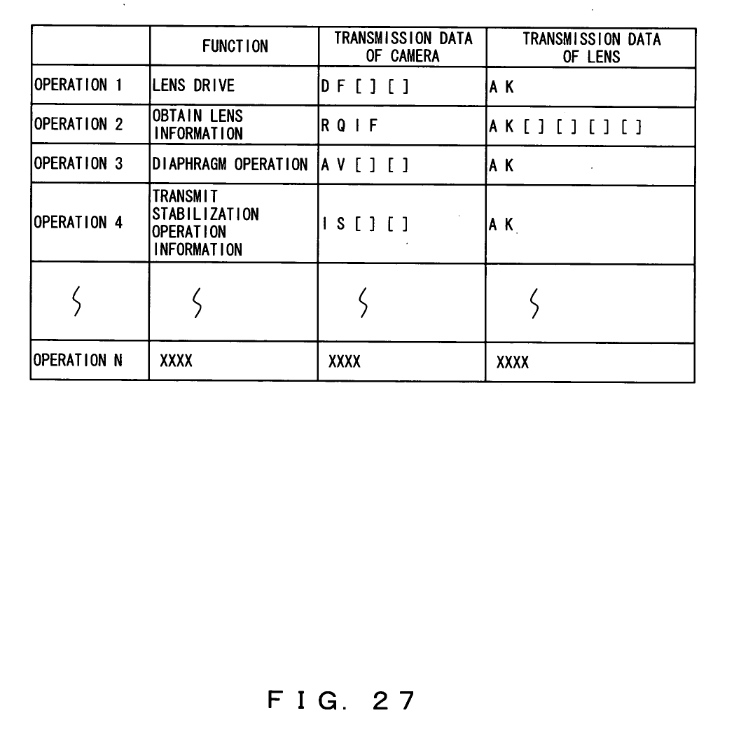

At this point, the description by referring to FIG. 27 is of a communication process performed between the system controller 204 and lens control computer 106 which control the camera body 200 and photo lens 100, respectively, before describing a photographing operation of a camera system.

FIG. 27 exemplifies communication data (i.e., code) used for communications carried out between the system controller 204 and lens control computer 106 according to a desired operation.

An operation 1 is one carried out at the time of the camera body 200 adjusting a focus by driving the photo lens 100.

The system controller 204 transmits a character code “DF [ ] [ ]” to the lens control computer 106, where “DF” indicates that the communicated data is a displacement of a focus position (i.e., a defocus amount) and a value indicating a displacement of a focus lens is set for “[ ] [ ]” following the “DF”.

Having received a character code “DF [ ] [ ]”, the lens control computer 106 returns a character code “AK” (Acknowledge) to the system controller 204. Then the lens control computer 106 drives the photo lens 100 for performing a focus adjustment operation.

An operation 2 is one executed at the time of the camera body 200 obtaining lens information.

The system controller 204 transmits a character code “RQINF” (ReQuest INFormation) to the lens control computer 106.

Having received the character code “RQINF”, the lens control computer 106 returns a character code “AK [ ] [ ] [ ] [ ]” to the system controller 204. A state of the lens (e.g., a state of the lens operation switch 108) and a lens parameter (e.g., focal distance, lens category, full open F-number, et cetera) are set in the “[ ] [ ] [ ] [ ]” following the “AK”.

An operation 3 is one executed at the time of the camera body 200 setting up the diaphragm of the lens.

The system controller 204 transmits a character code “AV [ ] [ ]” to the lens control computer 106. The “AV” indicates that the communicated data is an aperture value of the diaphragm of the lens. A value of the diaphragm to be set is designated for the “[ ] [ ]” following the “AV”.

Having received the character code “AV [ ] [ ]”, the lens control computer 106 returns a character code “AK” to the system controller 204, and adjusts the diaphragm 101b by making the actuator drive circuit 104 operate based on the received aperture value of the diaphragm.

An operation 4 is one for transmitting information relating to each camera shake correction means (i.e., stabilization operation information), et cetera, in the case of comprising a plurality of camera shake correction means within a camera system (e.g., the case of enabling a camera shake correction both in the camera body 200 and photo lens 100).

For instance, it is used for the camera body 200 judging whether or not to permit a camera shake correction operation on the photo lens 100 side according to a designated operation mode.

The system controller 204 transmits a character code “IS [ ] [ ]” to the lens control computer 106. In this event, the “[ ] [ ]” following the “IS” (Image Stabilize) is setup with information indicating whether or not to permit a camera shake correction operation.

Having received the character code “IS [ ] [ ]”, the lens control computer 106 returns a character code “AK” to the system controller 204 and judges whether or not to carry out a stabilization operation.

Note that the present invention is contrived to utilize the operations 1 and 3 for instructing a start of a stabilization operation on the photo lens 100 side. However, the operations 1 and 3 are not the communication operations furnished only for controlling a stabilization operation, but they are provided with a plurality of meanings for preventing an increase of the kinds of communication operations.

In the meantime, the above described communication process performed between the system controller 204 and lens control computer 106 which control the camera body 200 and the photo lens 100, respectively, is apparently the same for the second and the third embodiments.

FIGS. 3A and 3B show a flow chart showing a photographing operation of a camera system according to the first embodiment. The following is a description of a stabilization operation of a camera system according to the first embodiment based on the flow chart.

As the camera operation switch 213 is operated, an interrupt signal is input to the system controller 204, for example, and the MPU comprised thereby executes a program stored in a prescribed address within the Flash Rom 216 in response to the interrupt signal, thereby starting a photographing operation, et cetera (S300).

Note that while the process described in the following is implemented by the MPUs respectively comprised by the lens control computer 106 and system controller 204 executing instructions described in a prescribed program, the description of the present specification handles the lens control computer 106 and system controller 204 as the subjects of the respective processes for the reason of simplification.

As the photographing operation is started, the system controller 204 checks whether or not the first release switch becomes an ON state by the release switch 213a. If the first release switch is not in an ON state (i.e., an OFF state), it repeats the process of the S301 until the first release switch becomes an ON state.

If the first release switch becomes the ON state in the S301, the system controller 204 shifts the process to the S302 and calculates a defocus amount from an output of the AF sensor 210, followed by calculating an aperture value of the diaphragm from an output value of the photometry circuit 211.

Upon finishing the calculation of the defocus amount, et cetera, the system controller 204 shifts the process to the S303 and notifies the lens control computer 106 of the defocus amount calculated in the S302 by a communication with the lens control computer 106 comprised by the photo lens 100.

Meanwhile, having obtained the defocus amount by the communication with the system controller 204 in the S401, the lens control computer 106 shifts the process to the S402 and drives the actuator drive circuit 104 according to the obtained defocus amount, thereby adjusting the position of the focus lens 101a.

Having completed the transmission of the defocus amount in the S303, the system controller 204 shifts the process to the S304.

Then the system controller 204 checks whether or not the second release switch becomes an ON state by the release switch 213a. If the second release switch is not in an ON state (i.e., an OFF state), it repeats the process of the S304 until the second release switch becomes an ON state.

If the second release switch becomes an ON state in the S304, the system controller 204 shifts the process to the S305 and carries out a communication with the lens control computer 106 of the photo lens 100 and obtains setup information of the lens operation switch 108. A setting of the lens stabilization switch 108a among the obtained lens operation switch 108 is stored in lens stabilization switch information of the stabilization display data 220.

Meanwhile, the lens control computer 106 refers to the Flash ROM 107, reads setup information of the lens operation switch 108 from a predefined address and transmits it to the system controller 204 according to a request from the system controller 204 for the setup information of the aforementioned lens operation switch 108 in the S403.

Having obtained the setup information of the lens operation switch 108 from the lens control computer 106, the system controller 204 shifts the process to the S306 and transmits the aperture value of the diaphragm calculated in the S302 to the lens control computer 106.

Meanwhile, having obtained the aperture value of the diaphragm transmitted from the system controller 204 in the S404, the lens control computer 106 shifts the process to the S405 and adjusts the diaphragm 101b by making the actuator drive circuit 104 drive according to the aforementioned aperture value of the diaphragm.

The lens control computer 106 moves the correction lens 101c to the original position by operating the correction lens shift mechanism 103 and actuator drive circuit 104 in the S4051. This centering operation sets the correction lens 101c at the center position (i.e., the original position) in the range allowing a shift. Note that the centering operation needs to be carried out before starting a stabilization operation. The present embodiment is configured to start a stabilization operation in the S408 described later.

Here, a centering operation needs to be carried out for the photo lens 100 and camera body 200 in either case, i.e., of performing a stabilization operation on the photo lens 100 side and a stabilization operation on the camera body 200 side.

This is because of a possibility of the correction lens 101c moving to an edge of the movement range due to an unintentionally added shock even if a stabilization operation is not carried out on the photo lens 100 side for instance. If a stabilization operation is performed on the camera body 200 side in such a state, a problem occurs where the imaging device 202 shifts to a range outside the image circle of the photo lens 100.

Likewise, there is a possibility of the imaging device 202 moving to an edge of the movement range due to an unintentionally added shock even if a stabilization operation is not carried out on the camera body 200 side. If a stabilization operation is performed on the photo lens 100 side in such a state, a problem occurs where the correction lens 101c shifts to a range outside the image circle of the photo lens 100.

Therefore, a centering operation is carried out in response to the communication process performed between the photo lens 100 and camera body 200 following the second release switch becoming an ON state on the photo lens 100 side. On the camera body 200 side, also, the centering operation is performed after the second release switch is detected being an ON stage that is right before an imaging operation.

Upon completing the transmission of the aperture value of the diaphragm to the lens control computer 106 in the S306, the system controller 204 shifts the process to the S307 and carries out a mirror UP operation in which the quick return mirror 201a moves to the direction “a” (refer to FIG. 1) so as to let the incident light incident to the imaging device 202 by driving the mirror drive mechanism 205.

The system controller 204 operates the imaging device shift mechanism 207 and actuator drive circuit 208, thereby making the imaging device 202 move to the original position in the S3071. This centering operation sets the imaging device 202 at the center position (i.e., the original position) in the range allowing a shift. This centering operation also needs to be performed before starting a stabilization operation. The present embodiment is configured to start the stabilization operation in the later described S308.

Upon completing the centering operation, the system controller 204 shifts the process to the S308 and performs the stabilization selection process for selecting a use of either of the stabilization functions, i.e., the one comprised by the photo lens 100 (which is called “lens stabilization” hereinafter) or the one comprised by the camera body 200 (which is called “body stabilization” hereinafter).

In the S308, the system controller 204 performs a stabilization selection process based on the setup information of the lens stabilization switch 108a and that of the body stabilization switch 213b, which are obtained in the S305, and the stabilization mode described associated with FIG. 2. It starts a body stabilization operation in the present S308 in the case of using the body stabilization. In this event, it clears a lens stabilization flag to “0” for controlling the lens stabilization.

In the case of using the lens stabilization, it sets the lens stabilization flag to “1” in the present S308 and shifts the process to the S309.

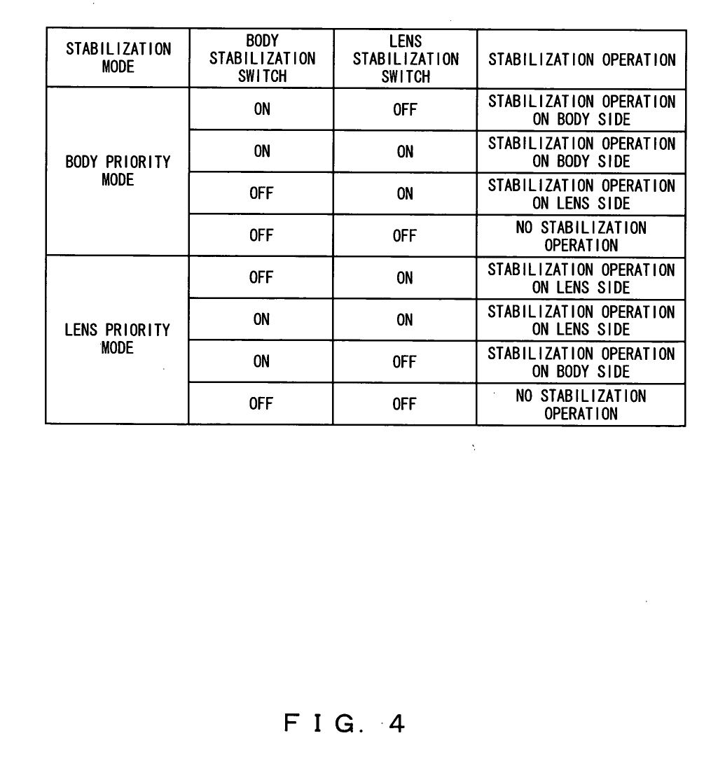

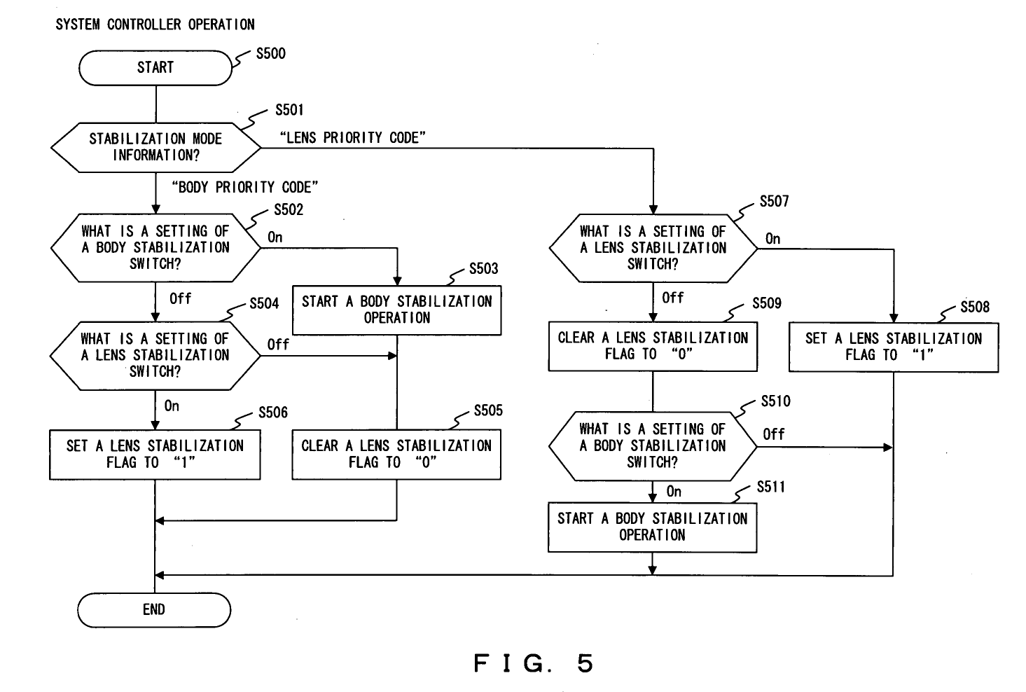

Note that if the lens stabilization flag is “0”, the lens stabilization is meant to be not used, while if the lens stabilization flag is “1”, the lens stabilization is meant to be used, according to the present embodiment. Note also that a detail of the stabilization selection process is described later based on FIGS. 4 and 5.

Then, the system controller 204 transmits the lens stabilization flag, which has been generated by the process of the S308, to the lens control computer 106.

Meanwhile, having received the lens stabilization flag from the system controller 204 in the S406, the lens control computer 106 shifts the process to the S407, discerns whether or not the lens stabilization flag is “0” and, if it is “1”, shifts the process to the S408, followed by starting a lens stabilization operation.

In this event, for example, the system controller 204 sets a code in the lens stabilization operation information of the stabilization display data 220 for indicating “in operation” and also stores a code indicating “in stop” in the body stabilization operation information.

Having completed the transmission of the lens stabilization flag in the S309, the system controller 204 shifts the process to the S310, drives the actuator drive circuit 208, thereby making the shutter 201d in an OPEN state and starts an imaging.

Then, when a predefined period of time elapses, the system controller 204 shifts the process to the S311, makes the shutter 201d a CLOSE state again and also notifies the lens control computer 106 of the end of the exposure.

Meanwhile, having received a notification of the end of the exposure from the system controller 204 in the S409, the lens control computer 106 shifts the process to the S410 and, if a lens stabilization operation is in execution, shifts the process to the S411, ends it. In this event, the lens control computer 106 also sets a code indicating “in stop” in the lens stabilization operation information of the stabilization display data 220.

Either a lens stabilization operation is not in execution, or upon completing the stop of a lens stabilization operation in the S410, the lens control computer 106 shifts the process to the S412, makes the actuator drive circuit 104 operate and opens the diaphragm 101b to end the process (S413).

Upon completing the exposure in the S311, the system controller 204 shifts the process to the S312 and, if the body stabilization is in operation, shifts the process to the S313 to stop the body stabilization; and sets a code indicating “in stop” in the body stabilization operation information of the stabilization display data 220 in this event.

If a body stabilization is not in operation in the S312 or upon completing the stop of the body stabilization operation in the S313, the system controller 204 shifts the process to the S314, makes the actuator drive circuit 208 drive and carries out a mirror Down operation for moving the quick return mirror 201a to the direction “b” (refer to FIG. 1) so as to let the incident light incident to the penta prism 201b by being reflected by the quick return mirror 201a.

Upon completing the mirror Down operation, the system controller 204 shifts the process to the S315, reads image data from the imaging device 202 by way of the imaging device IF circuit 203 and compresses the aforementioned image data for storing it in the recording medium 214. In this event, the configuration may be such that the system controller 204 stores, by correlating with the aforementioned image data, the stabilization display data 220 at the time of photographing (e.g., at the time of S310) in a header part of data compliant to the Exif Standard (which is called “Exif data” hereinafter) for example.

Upon completing the above described process, a photographing operation ends (S316).

FIG. 4 is a diagram describing a stabilization operation operated by a stabilization selection process according to the first embodiment. A stabilization operation table shown by FIG. 4 indicates a correlation among a stabilization mode, a body stabilization switch 213b, a lens stabilization switch 108a and a stabilization operation.

In the case of a stabilization mode being a body priority mode, the body stabilization is operated if the body stabilization switch 213b is in an ON state regardless of an ON or OFF state of the lens stabilization switch 108a. And in the case of the body stabilization switch 213b being in an OFF state, a lens stabilization is operated if the lens stabilization switch 108a is in an ON state. In the state of both of the body stabilization switch 213b and lens stabilization switch 108a being in an OFF state, a stabilization operation is not performed.

Meanwhile, in the case of a stabilization mode being the lens priority mode, it is operated if the lens stabilization switch 108a is in an ON state regardless of the body stabilization switch 213b being either in an ON or OFF mode. And in the case of the lens stabilization switch 108a being in an OFF state, the body stabilization is operated if the body stabilization switch 213b is in an ON state. And in the case of both of the lens stabilization switch 108a and body stabilization switch 213b being in an OFF state, a stabilization operation is not carried out.

FIG. 5 is a flow chart showing a detailed process of a stabilization selection process in the step S308 shown in FIG. 3A.

In the S307 shown in FIG. 3A, upon completing a mirror Up operation, the system controller 204 shifts the process to the S500 and starts a stabilization selection process.

In the S501, the system controller 204 refers to stabilization information stored in a prescribed address of the Flash Rom 216, and discerns whether the stabilization mode is the lens priority mode or the body priority mode. If the stabilization mode is the body priority mode (e.g., the body priority mode is set in the stabilization mode information), it shifts the process to the S502, while if the stabilization mode is the lens priority mode (e.g., the lens priority mode is set in the stabilization mode information), it shifts the process to the S507.

Shifting to the S502, the system controller 204 obtains On/Off information of the body stabilization switch 213b and also stores the obtained On/Off information in the body stabilization switch information of the stabilization display data 220, followed by starting a body stabilization operation by shifting the process to the S503 if the body stabilization switch 213b is in an ON state.

In this event, the system controller 204 sets a code indicating “in operation” in the body stabilization operation information of the stabilization display data 220, for example, and also stores a code indicating “in stop” in the lens stabilization operation information, followed by shifting the process to the S505, clearing the lens stabilization flag to “0” and ending the stabilization selection process.

Meanwhile, if the body stabilization switch 213b is in an OFF state in the S502, the system controller 204 shifts the process to the S504, checks a state of the lens stabilization switch 108a and, if it is in an OFF state, shifts the process to the S505, clears the lens stabilization flag to “0” and ends the stabilization selection process.

Contrarily, if the lens stabilization switch 108a is in an ON state in the S504, the system controller 204 sets the lens stabilization flag to “1” and ends the stabilization selection process.

On the other hand, upon shifting from the S501 to S507, the system controller 204 checks a state of the lens stabilization switch 108a and, if it is in an ON state, shifts the process to the S508, followed by setting the lens stabilization flag to “1” and ending the stabilization selection process.

If the lens stabilization switch 108a is in an OFF state in the S507, it shifts the process to the S509 and clears the lens stabilization flag to “0”, followed by shifting the process to the S510 upon ending the clearing process of the lens stabilization flag.

The system controller 204 obtains On/Off information of the body stabilization switch 213b and stores the obtained On/Off information in the body stabilization switch information of the stabilization display data 220 in the S510, followed by ending the stabilization selection process if the body stabilization switch 213b is in an OFF state, while shifting the process to the S511 if the body stabilization switch 213b is in an ON state.

The system controller 204 starts a body stabilization operation in the S511. The system controller 204 also sets a code indicating “in operation” in the body stabilization operation information of the stabilization display data 220, for example, and also stores a code indicating “in stop” in the lens stabilization operation information, followed by ending the stabilization selection process.

As described above, the camera system according to the present embodiment is configured to bring forth a benefit of enabling a photographing by making a desired stabilization correction function operate by a simple operation of a user setting the mode setup switch 213c for either the lens priority mode or the body priority mode.

While the present embodiment is configured to enable a discretionary setup of a stabilization mode (i.e., the lens priority mode or body priority mode) by an operation of the mode setup switch 213c, yet another configuration may be such as to set, by storing in the Flash Rom 216, et cetera, either the lens priority mode or body priority mode as preset mode for example and the aforementioned set/stored mode is used as the stabilization mode.

Here, the first embodiment described above has exemplified the case of having stabilization functions both in the photo lens 100 and camera body 200. Yet the camera system according to the present embodiment is capable of accomplishing a stabilization function simply by comprising an angular velocity sensor for detecting a camera shake amount and a correction mechanism for correcting the detected camera shake amount (i.e., a correction lens shift mechanism for making an image forming position shift within a plane perpendicular to the optical axis, or an imaging device shift mechanism for making an imaging device shift within a plane perpendicular to the optical axis) in either one or both of the photo lens 100 and camera body 200.

Here, the correction lens shift mechanism is defined by a correction optical system implemented by the correction lens 101c, correction lens shift mechanism 103, actuator drive circuit 104 and lens control computer 106 which are shown in FIG. 1, for example. And the imaging device shift mechanism is defined by a shift mechanism implemented by the imaging device 202, imaging device shift mechanism 207, actuator drive circuit 208 and system controller 204 which are shown in FIG. 1, for example.

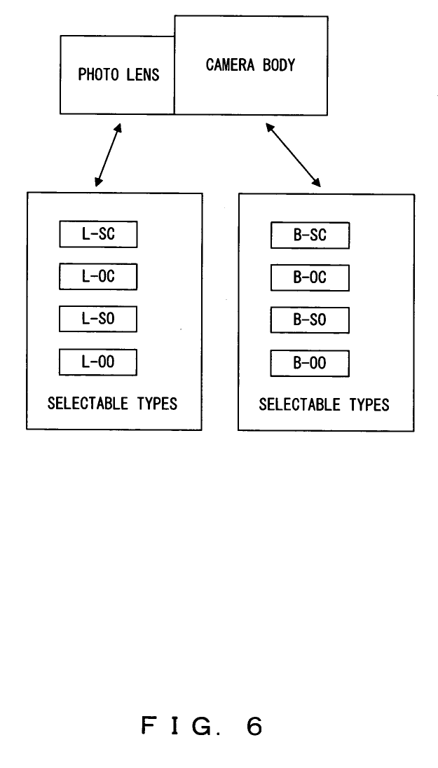

FIG. 6 exemplifies a configuration of a camera system having an equivalent stabilization function to a camera system according to the first embodiment. As shown in FIG. 6, conceivable types as a photo lens 100 include a photo lens L-SC comprising a sensor such as angular velocity sensor for measuring a camera shake amount (simply “sensor” hereinafter) and a correction mechanism, a photo lens L-0C comprising no sensor but a correction mechanism, a photo lens L-S0 comprising a sensor and no correction mechanism, and a photo lens L-00 comprising neither sensor nor correction mechanism.

Therefore, a user can select either one out of the L-SC, L-0C, L-S0 and L-00 as a photo lens. Incidentally, an L stands for lens, an S stands for sensor and a C stands for correction. And a “0” means having no sensor, or having no correction mechanism.

Meanwhile, conceivable types as a camera body 200 include a camera body B-SC comprising a sensor and a correction mechanism, a camera body B-0C comprising no sensor but a correction mechanism, a camera body B-S0 comprising a sensor and no correction mechanism, and a camera body B-00 comprising neither sensor nor correction mechanism.

Therefore a user can select either one out of the B-SC, B-0C, B-S0 and B-00 as a camera body. Incidentally, a B stands for body, an S stands for sensor and a C stands for correction. And a “0” means having no sensor, or having no correction mechanism.

A camera system constituted by the above described photo lens and camera body constitutes one capable of carrying out a stabilization function if there is at least one of “S” and “C” existing in a character string indicating a configured type, e.g., a combination of L-S0 and B-0C, and that of L-0C and B-S0, et cetera.

Here, there are systems which include a plurality of comprisals capable of stabilization as a configuration of a camera system capable of carrying out a stabilization function. That is, combinations such as L-S0 and B-SC, and L-0C and B-SC.

A camera system combining the L-S0 with B-SC enables the use of both sensors, i.e., the sensor equipped on the camera body and one equipped on the photo lens, for detecting a camera shake amount.

In this case, the process shown in FIG. 2 is carried out by using the mode setup switch 213c shown in FIG. 2, and either a lens priority mode or a body priority mode is set in a stabilization mode.

And a configuration is such that the system controller 204 obtains a type of a photo lens (e.g., L-S0) which is stored in the Flash ROM 107 by communicating with the lens control computer 106 and also reads a type of a camera body (e.g., B-SC) which is stored in the Flash Rom 216, thereby selecting an angular velocity sensor according to a stabilization mode, for example.

And in a camera system combining the L-0C with B-SC, a correction operation for preventing a degradation of an image according to a camera shake amount may use a correction lens shift mechanism comprised by the photo lens, or an imaging device shift mechanism comprised by the camera body. A shift mechanism to be used in priority may be configured to be selectable as in the camera system shown in FIG. 1.

Also in this case, the process shown in FIG. 2 is carried out by using the mode setup switch 213c shown in FIG. 2, and either a lens priority mode or a body priority mode is set for the stabilization mode.

And a configuration is such that the system controller 204 obtains a type of a photo lens (e.g., L-0C) which is stored in the Flash ROM 107 by communicating with the lens control computer 106 and also reads a type of a camera body (e.g., B-SC) which is stored in the Flash Rom 216, thereby selecting a shift mechanism and making it operate according to a stabilization mode, for example.

The following describes concrete configurations of the photo lenses L-SC, L-0C, L-S0 and L-00, followed by describing concrete configurations of the camera bodies B-SC, B-0C, B-S0 and B-00. Incidentally, the L-SC indicates the photo lens 100 described associated with FIG. 1 and the B-SC indicates the camera body 200 described associated with FIG. 1, and therefore their descriptions are omitted here.

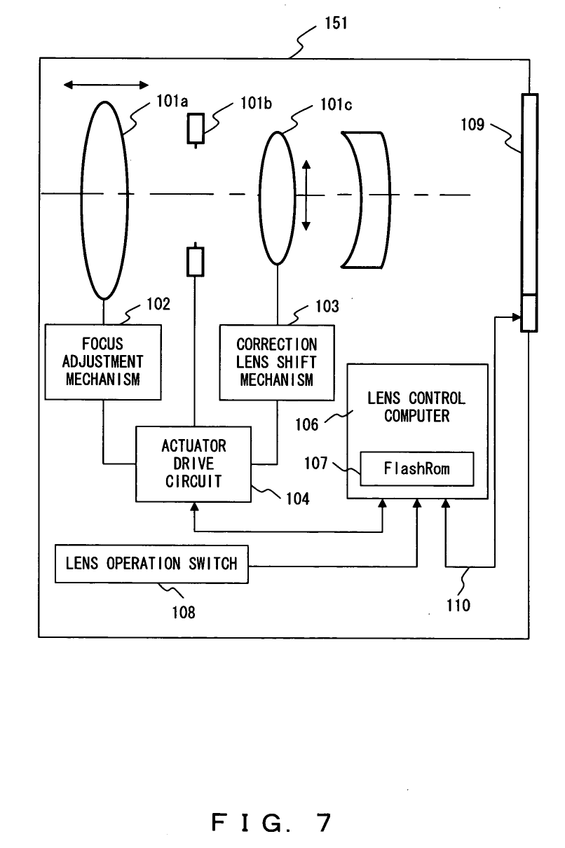

FIG. 7 is a diagram exemplifying a configuration of an L-0C type photo lens 151. The photo lens 151 shown by FIG. 7 is a photo lens comprising no sensor but a correction mechanism. The difference from the photo lens 100 shown in FIG. 1 lies in not comprising an angular velocity sensor 105.

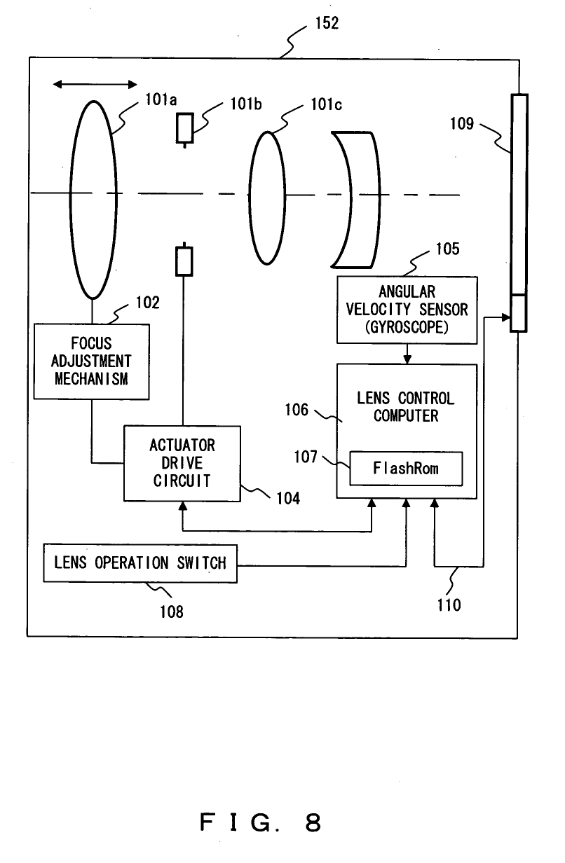

FIG. 8 is a diagram exemplifying a configuration of an L-S0 type photo lens 152. The photo lens 152 shown by FIG. 8 is a photo lens comprising a sensor and no correction mechanism. The difference from the photo lens 100 shown in FIG. 1 lies in not comprising a correction lens shift mechanism 103.

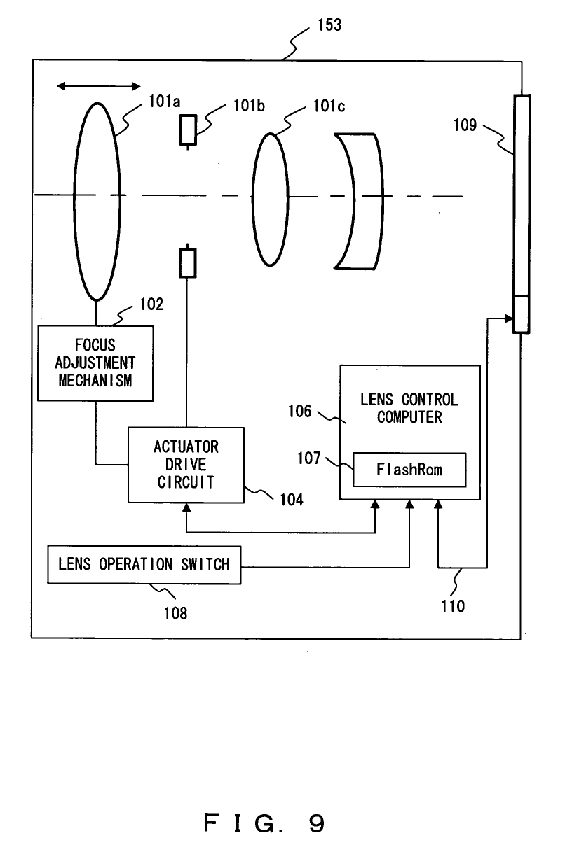

FIG. 9 is a diagram exemplifying a configuration of an L-00 type photo lens 153. The photo lens 153 shown by FIG. 9 is a photo lens comprising neither sensor nor correction mechanism. The difference from the photo lens 100 shown in FIG. 1 lies in not comprising a correction lens shift mechanism 103 or angular velocity sensor 209.

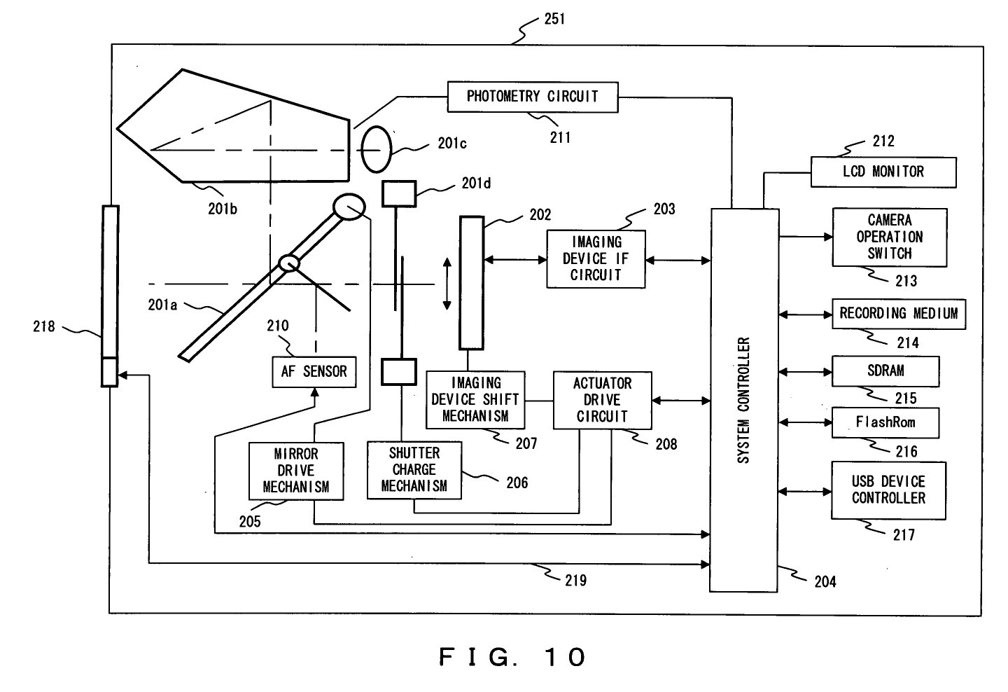

FIG. 10 is a diagram exemplifying a configuration of a B-0C type camera body 251. The camera body 251 is a camera body comprising no sensor but a correction mechanism. The difference from the camera body 200 shown in FIG. 1 lies in not comprising an angular velocity sensor 209.

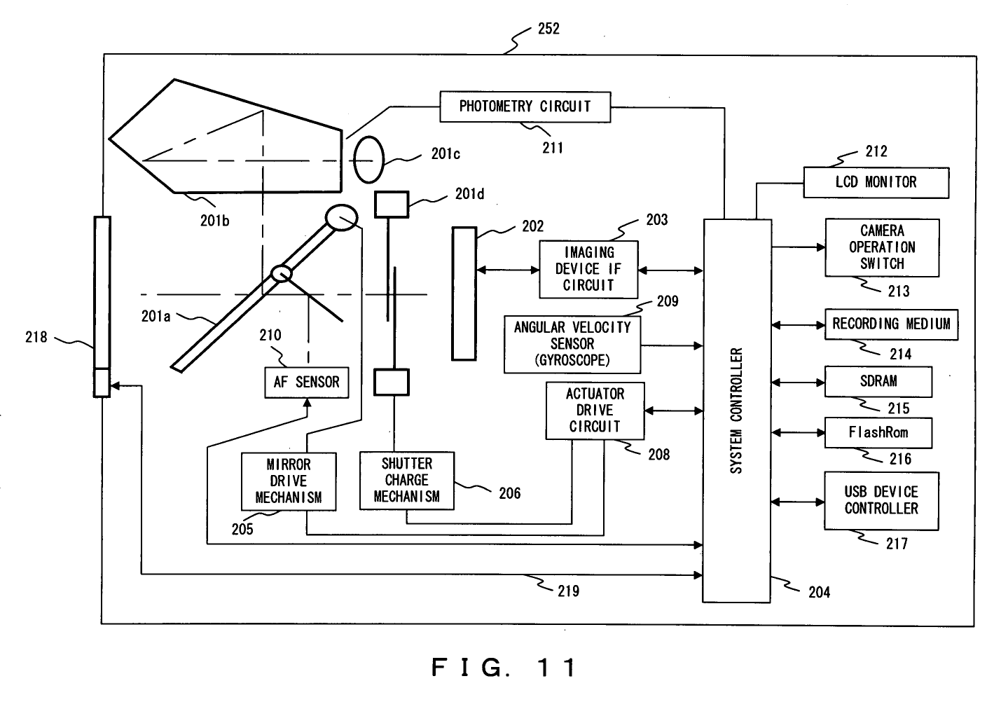

FIG. 11 is a diagram exemplifying a configuration of a B-S0 type camera body 252. The camera body 252 shown by FIG. 11 is a camera body comprising a sensor but no correction mechanism. The difference from the camera body 200 shown in FIG. 1 lies in not comprising an imaging device shift mechanism 207.

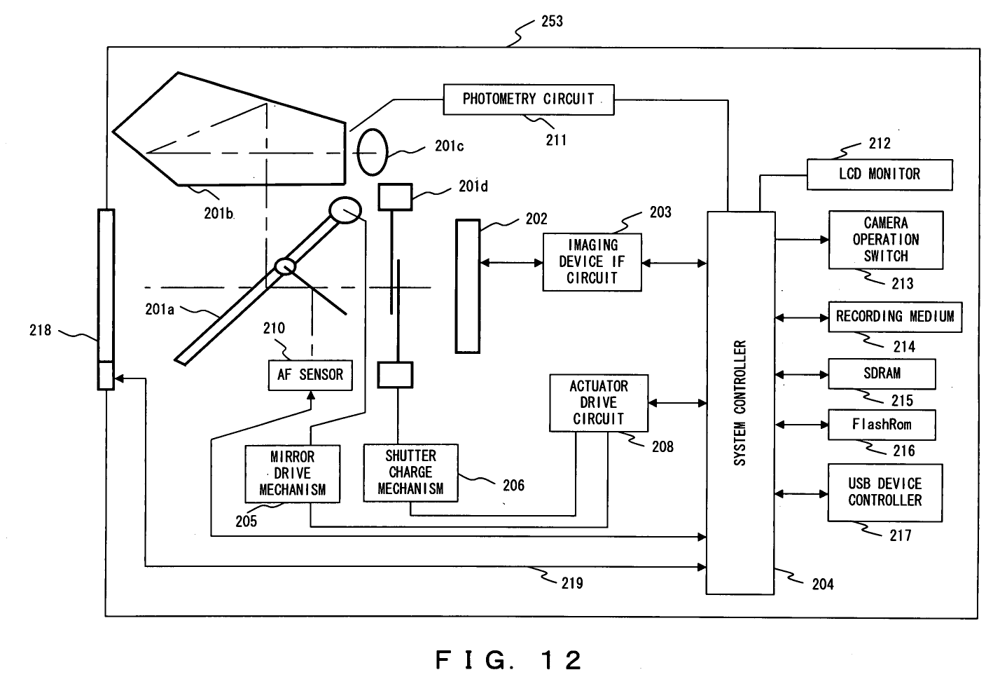

FIG. 12 is a diagram exemplifying a configuration of a B-00 type camera body 253. The camera body 253 shown by FIG. 12 is a camera body comprising neither sensor nor correction mechanism. The difference from the camera body 200 shown in FIG. 1 lies in not comprising an imaging device shift mechanism 207 or an angular velocity sensor 209.

Incidentally, there are camera systems equipped (i.e., connecting) with one, or two or more, of converter lens(es) between a photo lens and a camera body, in addition to the above described camera system comprised of a photo lens and a camera body.

Therefore, it is possible to accomplish a stabilization function in a camera system comprising a photo lens, a converter lens and a camera body if at least either one of the photo lens, converter lens and camera body comprises one sensor and one correction mechanism.

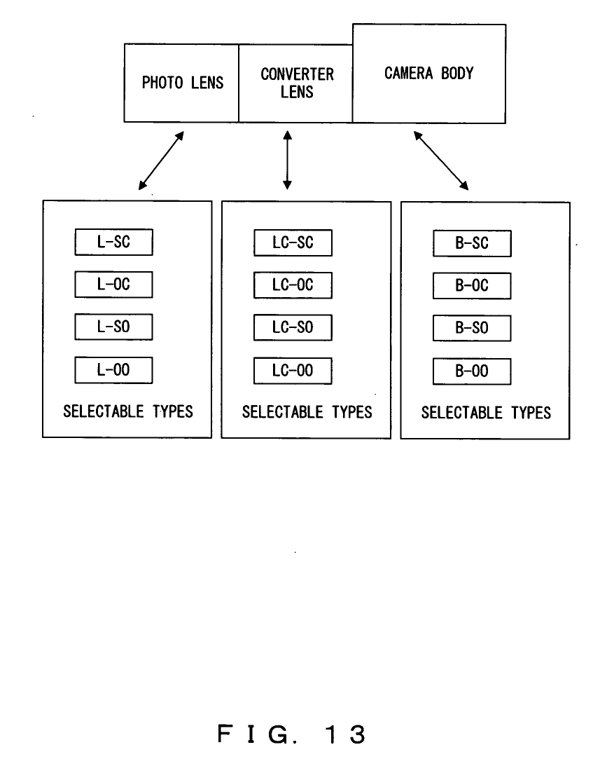

As shown in FIG. 13, conceivable types as a photo lens include a photo lens L-SC comprising a sensor and a correction mechanism, a photo lens L-0C comprising no sensor but a correction mechanism, a photo lens L-S0 comprising a sensor and no correction mechanism, and a photo lens L-00 comprising neither sensor nor correction mechanism.

Meanwhile, conceivable types as a camera body include a camera body B-SC comprising a sensor and a correction mechanism, a camera body B-0C comprising no sensor but a correction mechanism, a camera body B-S0 comprising a sensor and no correction mechanism and a camera body B-00 comprising neither sensor nor correction mechanism.

Moreover, conceivable types as a converter lens include a converter lens LC-SC comprising a sensor and a correction mechanism, a converter lens LC-0C comprising no sensor but a correction mechanism, a converter lens LC-S0 comprising a sensor and no correction mechanism, and a converter lens LC-00 comprising neither sensor nor correction mechanism.

Incidentally, an LC stands for converter lens, an S stands for sensor and a C stands for correction. And a “0” means having no sensor, or having no correction mechanism.

A camera system constituted by the above described photo lens, converter lens and camera body constitutes a camera system capable of carrying out a stabilization function if there is at least each one of “S” and “C” existing in a character string indicating a configuration type, e.g., a combination of L-00, LC-0C and B-S0, and that of L-00, LC-0C and B-S0, et cetera.

Meanwhile, there are systems which include a plurality of comprisals capable of stabilization as a configuration of a camera system capable of carrying out a stabilization function. That is, combinations of such as L-00, LC-SC and B-S0, and L-00, LC-0C and B-SC.

A camera system combining the L-00 with LC-SC and B-S0 enables the use of both sensors, i.e., the sensor equipped on the converter lens and one equipped on the camera body, for detecting a camera shake amount.

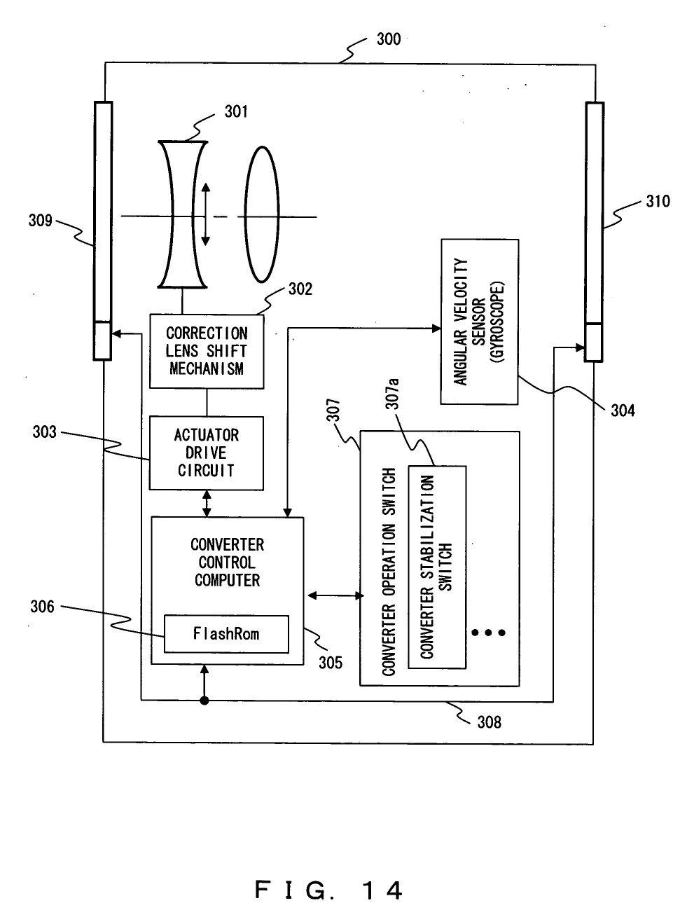

This case is equipped with a converter priority mode for operating according to a setup of a converter lens stabilization switch (e.g., refer to FIG. 14) as in priority for example, in addition to the lens priority mode for operating according to a setup of the lens stabilization switch 108a as in priority and the body priority mode for operating according to a setup of the body stabilization switch 213b as in priority, as settable modes by the mode setup switch 213c shown in FIG. 1.

And the process shown in FIG. 2 is carried out, thereby setting either a lens priority mode, a body priority mode or a converter lens priority mode for a stabilization mode.

And a configuration is such that the system controller 204 obtains a type of a photo lens (e.g., L-00) and a type of a converter lens (e.g., LC-SC) which are stored in the Flash ROM 107 and Flash ROM 306 by communicating with the lens control computer 106 and converter lens 300, and also reads a type of a camera body (e.g., B-S0) which is stored in the Flash Rom 216, thereby selecting an angular velocity sensor according to a stabilization mode, for example.

And in a camera system combining the L-00 with LC-0C and B-SC, a correction operation for preventing a degradation of an image according to a camera shake amount may use a correction lens shift mechanism comprised by the converter lens, or an imaging device shift mechanism comprised by the camera body. A shift mechanism to be used in priority may be configured to be selectable as in the camera system shown in FIG. 1.

This case is also equipped with a converter priority mode for operating according to a setup of a converter lens stabilization switch (e.g., refer to FIG. 14) as in priority for example, in addition to the lens priority mode for operating according to a setup of the lens stabilization switch 108a as in priority and the body priority mode for operating according to a setup of the body stabilization switch 213b as in priority, as settable modes by the mode setup switch 213c shown in FIG. 1.

Also the process shown in FIG. 2 is carried out, and either of a lens priority mode, a body priority mode or a converter priority mode is set for a stabilization mode.

And a configuration is such that the system controller 204 obtains a type of a photo lens (e.g., L-00) and a type of a converter lens (e.g., LC-0C) which are stored in the Flash ROM 107 and Flash ROM 306 respectively by communicating with the lens control computer 106 and converter lens 300, and also reads a type of a camera body (e.g., B-SC) which is stored in the Flash Rom 216, thereby selecting a shift mechanism and making it operate according to a stabilization mode, for example.

The following describe concrete configurations of the converter lenses LC-SC, LC-0C, LC-S0 and LC-00.

FIG. 14 is a diagram exemplifying a configuration of an LC-SC type converter lens 300.

The converter lens 300 shown in FIG. 14 comprises an optical system having at least a correction lens 301 for changing the optical axis of an incident light, a correction lens shift mechanism 302 for making the correction lens 301 shift on a plane perpendicular to the optical axis or making it tilt, an actuator drive circuit 303 for driving the correction lens shift mechanism 302, an angular velocity sensor 304 for detecting a vibration (i.e., a camera shake) of the converter lens 300, a converter control computer 305 for carrying out a stabilization operation according to an instruction of the camera body 200, a Flash Rom 306 for storing a program for operating the converter control computer 305, et cetera, and a converter operation switch 307 which is a switch for changing over between an enablement and a disablement of the stabilization function.

In the above described configuration, the converter operation switch 307 comprises at least a converter stabilization switch 307a for instructing as to whether or not a stabilization operation of the converter lens 300 is to be operated.

The converter control computer 305 drives the actuator drive circuit 303 for making the correction lens shift mechanism 302 operate according to an instruction of the camera body 200.

The converter control computer 305 also calculates a camera shake amount by applying an integration process to an angular velocity measured by the angular velocity sensor 304 and makes the actuator drive circuit 303 drive so as to correct the aforementioned camera shake amount. As a result, the correction lens 301 shifts and the optical axis shifts so as to correct the camera shake amount.

For example, the photo lens 100 is detachably connected to the converter lens 300 by an L mount 109 and a CB mount 309, while the converter lens 300 is detachably connected to the camera body 200 by a CL mount 310 and a B mount 218. Thereby the optical system comprised by the photo lens 100, the one comprised by the converter lens 300 and the one comprised by the camera body 200 are connected with each other.

And the lens-side communication line 110 comprised by the photo lens 100 is connected to a converter-side communication line 308 by way of the L mount 109 and CB mount 309, while the converter-side communication line 308 is connected to the body-side communication line 219 by way of the CL mount 310 and B mount 218.

And the lens control computer 106, system controller 204 and converter control computer 305 are configured to be mutually communicable.

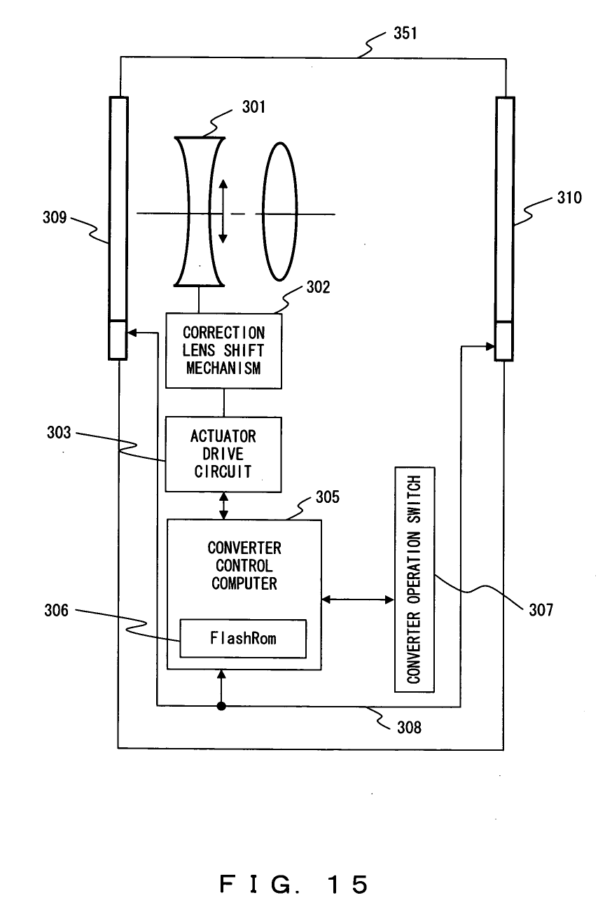

FIG. 15 is a diagram exemplifying a configuration of an LC-0C type converter lens 351. The converter lens 351 shown by FIG. 15 is a converter lens comprising no sensor but a correction mechanism. The difference from the converter lens 300 shown by FIG. 14 lies in not comprising an angular velocity sensor 304.

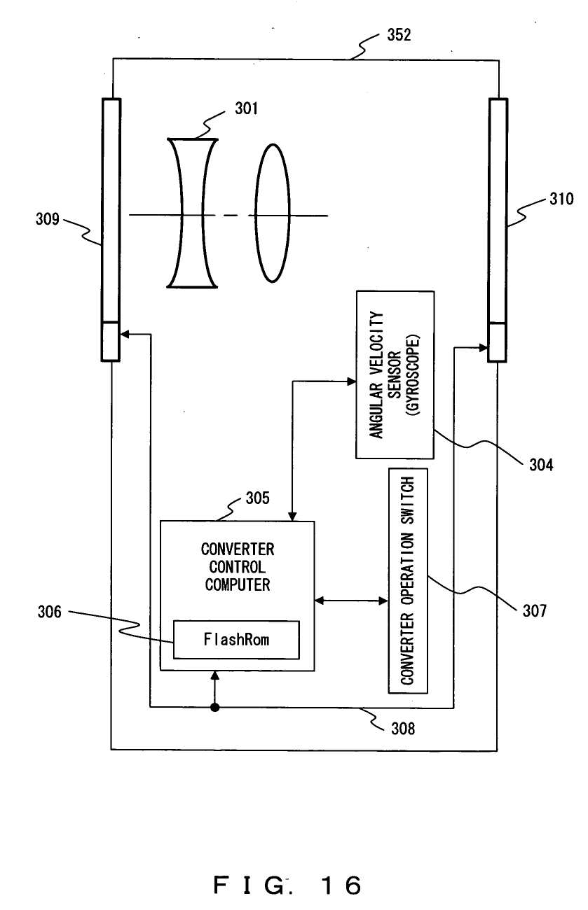

FIG. 16 is a diagram exemplifying a configuration of an LC-S0 type converter lens 352. The converter lens 352 shown by FIG. 16 is a converter lens comprising a sensor but no correction mechanism. The difference from the converter lens 300 shown by FIG. 14 lies in comprising neither correction lens shift mechanism 302 nor actuator drive circuit 303.

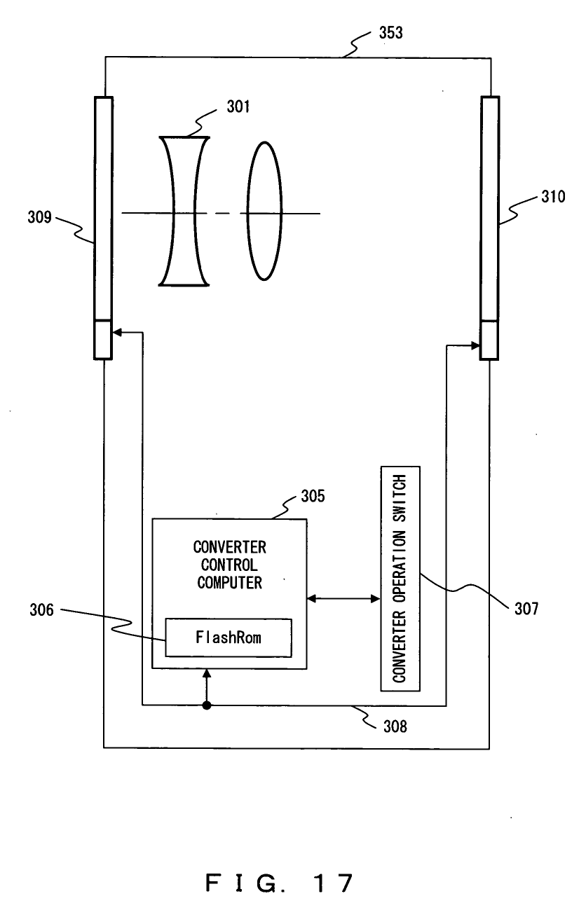

FIG. 17 is a diagram exemplifying a configuration of an LC-00 type converter lens 353. The converter lens 353 shown by FIG. 17 is a converter lens comprising neither sensor nor correction mechanism. The difference from the converter lens 300 shown by FIG. 14 lies in not comprising a correction lens shift mechanism 302, an actuator drive circuit 303 and an angular velocity sensor 304.

As described above, a camera system constituted by a camera body and a photo lens, or by a camera body, a photo lens and a converter lens includes a case of comprising a plurality of sensors for detecting a camera shake amount, or comprising a plurality of correction mechanisms. Also in such a condition, it is possible to carry out a stabilization function in response to a user's intention by providing a configuration enabling the user to select a sensor and a correction mechanism to be used in priority.

### (2) Second Embodiment

FIGS. 18A through 18C show a flow chart showing a photography operation of a camera system according to a second embodiment. The following describes a stabilization operation of the camera system according to the second embodiment based on the flow chart.

As a camera operation switch 213 is operated, an interrupt signal is input to a system controller 204, for instance, and an MPU comprised thereby executes a program stored in a predefined address within a Flash Rom 216 in response to the interrupt signal, thereby a photographing operation, et cetera, being started (S1800).

Note that while the process described in the following is implemented by the MPUs respectively comprised by a lens control computer 106 and a system controller 204 executing instructions described in a prescribed program, the description of the present specification handles the lens control computer 106 and system controller 204 as the subjects of the respective processes for the reason of simplification.

As the photographing operation is started, the system controller 204 checks whether or not the first release switch becomes an ON state by the release switch 213a. If the first release switch is not an ON state (i.e., an OFF state), it repeats the process of the S1801 until the first release switch becomes an ON state.

If the first release switch becomes the ON state in the S1801, the system controller 204 shifts the process to the S1802 and calculates a defocus amount from an output of the AF sensor 210, followed by calculating an aperture value of the diaphragm from an output value of the photometry circuit 211.

Upon finishing the calculation of the defocus amount, et cetera, the system controller 204 shifts the process to the S1803 and notifies the lens control computer 106 of the defocus amount (i.e., predefined control information) calculated in the S1802 to the lens control computer by a communication with the lens control computer 106 comprised by the photo lens 100.

Even if the defocus amount is zero (“0”) in this event, the system controller 204 transmits the defocus amount (“0”) to the lens control computer 106. It also transmits the defocus amount (“0”) even in the case of an MN/AF switch 108c is set for a manual focus.

Meanwhile, the lens control computer 106 obtains predefined data by a communication with the system controller 204 in the S1901.

In the S19011, the lens control computer 106 carries out a centering operation for making a correction lens 101c move to the original position by operating a correction lens shift mechanism 103 and an actuator drive circuit 104.

The present embodiment is configured to carry out a stabilization operation on the photo lens 100 side prior to a photography operation if a lens stabilization switch is in an ON state even if the body priority mode is selected, and therefore a centering operation is necessary. Note that a centering operation is necessary even in the case of a stabilization operation is not performed on the photo lens 100 side due to the reason already explained for the first embodiment.

In the S1902, the lens control computer 106 discerns whether or not the obtained predefined data is a defocus amount and, if the aforementioned predefined data is not a defocus amount, shifts the process to the S1906, while, if the aforementioned predefined data is a defocus amount, shifts the process to the S1903.

In the S1903, the lens control computer 106 obtains the state of a lens stabilization switch 108a and, if it is in an ON state, shifts the process to the S1904 and starts a lens stabilization operation (i.e., change operation states).

Contrarily if the lens stabilization switch 108a is in an OFF state, it shifts the process to the S1905 and adjusts the position of a focus lens 101a by driving the actuator drive circuit 104 according to the obtained defocus amount.

Having completed the transmission of the defocus amount in the S1803, the system controller 204 shifts the process to the S1804 and checks whether or not a second release switch has become an ON state by a release switch 213a. If the second release switch is not in an ON state (i.e., an OFF state), it repeats the process of the S1804 until the second release switch becomes the ON state.

If the second release switch becomes the ON state in the S1804, the system controller 204 shifts the process to the S1805 and obtains the setup information of a lens operation switch 108 by communicating with the lens control computer 106 of the photo lens 100.

Meanwhile, the lens control computer 106 refers to the Flash ROM 107, reads the setup information of the aforementioned lens operation switch 108 from the predefined address and transmits it to the system controller 204 according to a request from the system controller 204 for the setup information of the lens operation switch 108 in the S1906.

Having obtained the setup information of the lens operation switch 108 from the lens operation switch 108 in the S1805, the system controller 204 shifts the process to the S1806 and transmits the aperture value of the diaphragm (i.e., predefined control information) calculated in the S1802 to the lens control computer 106.

In this event, the system controller 204 transmits the aperture value of the diaphragm to the lens control computer 106 even if there is no change in the aforementioned aperture value of the diaphragm or if the value is “0”.

Meanwhile, the lens control computer 106 obtains predefined data by communicating with the system controller 204 in the S1907 and shifts the process to the S1908 when obtaining the predetermined data.

The lens control computer 106 discerns whether or not the obtained predefined data is an aperture value of the diaphragm in the S1908 and, if the aforementioned predetermined data is not an aperture value of the diaphragm, shifts the process to the S1912, while, if the aforementioned predetermined data is an aperture value of the diaphragm, shifts the process to the S1909, followed by adjusting the diaphragm 101b by making the actuator drive circuit 104 drive according to the aforementioned aperture value of the diaphragm.

Then, having completed the adjustment of the diaphragm 101b, the lens control computer 106 shifts the process to the S1910 and discerns whether or not the lens stabilization is in operation. If the lens stabilization is in operation, it shifts the process to the S1911 to stop the lens stabilization operation (i.e., change the operation states) and also moves the correction lens 101c to a predetermined position (i.e., return to the original position).

Having completed the transmission of the aperture value of the diaphragm to the lens control computer 106 in the S1806, the system controller 204 shifts the process to the S1807 and carries out a mirror Up operation for moving a quick return mirror 201a to the direction “a” (refer to FIG. 1) so as to let the incident light incident to the imaging device by making a mirror drive mechanism 205 drive.

The system controller 204 carries out a centering operation for making an imaging device 202 move to the original position by operating an imaging device shift mechanism 207 and an actuator drive circuit 208 in the S18071. Also in this case, a centering operation is necessary prior to starting a stabilization operation in the process of a later described S1808.

Upon completing the centering operation, the system controller 204 shifts the process to the S1808 and carries out a stabilization selection process for selecting which of the stabilization functions, i.e., the lens stabilization and body stabilization, is to be used.

The system controller 204 carries out the stabilization selection process in the S1808 based on the setup information of the lens stabilization switch 108a and that of the body stabilization switch 213b which are obtained in the S1805 and the stabilization mode described in association of FIG. 2. Then, it starts a body stabilization operation in the case of using the body stabilization in the present S1808, and clears the lens stabilization flag for controlling the lens stabilization to “0” in this event.

Contrarily, if the lens stabilization is used, the system controller 204 sets the lens stabilization flag to “1” in the present S1808 and shifts the process to the S1809.

Note that a lens stabilization flag being “0” means that a lens stabilization is not used, while the lens stabilization flag being “1” means that a lens stabilization is used, according to the present embodiment. Incidentally the details of the stabilization selection process have been described in association with FIGS. 4 and 5, and therefore the description is omitted here.

The system controller 204 transmits the lens stabilization flag generated by the process of the S1808 to the lens operation switch 108 in the S1809.

Meanwhile, having received the lens stabilization flag from the system controller 204 in the S1912, the lens control computer 106 shifts the process to the S1913, discerns whether or not the lens stabilization flag is “0” and, if it is “1”, shifts the process to the S1914 and starts the lens stabilization process.

Having completed the transmission of the lens stabilization flag in the S1809, the system controller 204 shifts the process to the S1810 and makes a shutter 201d an Open state by driving the actuator drive circuit 208 and starts an imaging.

Having a predetermined time elapsed, the system controller 204 shifts the process to the S1811, makes the shutter 201d return to a Close state and also notifies the lens control computer 106 of the end of the exposure.

Meanwhile, having received the notice of the end of the exposure from the system controller 204 in the S1914, the lens control computer 106 shifts the process to the S1915 and, if the lens stabilization operation is in operation, shifts the process to the S1916 to stop the lens stabilization operation.

If a lens stabilization is not in operation or completing the stop of the lens stabilization operation in the S1915, the lens control computer 106 shifts the process to the S1917, opens the diaphragm 101b by making the actuator drive circuit 104 drive and ends the process.

Upon ending the exposure in the S1811, the system controller 204 shifts the process to the S1812, shifts the process to the S1813 if the body stabilization is in operation and stops it.

If a body stabilization is not in operation in the S1812, or upon completing the stoppage of the body stabilization operation in the S1813, the system controller 204 shifts the process to the S1814 and makes the actuator drive circuit 208 drive, thereby carrying out a mirror Down operation for moving the quick return mirror 201a in the direction “b” (refer to FIG. 1) so as to let the incident light reflect on the quick return mirror 201a and be incident to the penta prism.

Upon completing the mirror Down operation, the system controller 204 shifts the process to the S1816, reads image data from the imaging device 202 by way of an imaging device IF circuit 203, stores the aforementioned image data in a recording medium 214 by compressing it and ends the process.

Stabilization operations functioned by the above described processes are shown by FIG. 19.

FIG. 19 is a diagram for describing a stabilization operation operated by a stabilization selection process according to the second embodiment.

The stabilization operation table shown by FIG. 19 shows the relationships between the stabilization modes, body stabilization switch 213b or lens stabilization switch 108 and stabilization operations. A stabilization operation 1 shown in FIG. 19 shows a stabilization operation from the first release by the release switch 213a through the prior to an exposure. And a stabilization operation 2 is a stabilization operation during an exposure.

In the case of a stabilization mode being the body priority mode, lens stabilization is operated if the lens stabilization switch 108a is in an ON state regardless of the body stabilization switch 213b being in an ON or OFF state during the first release through the prior to an exposure. And if the lens stabilization switch 108a is in an OFF state, lens stabilization is not operated.

Comparably, during an exposure, the body stabilization is operated if the body stabilization switch 213b is in an ON state regardless of the lens stabilization switch 108a being in an ON or OFF state. In the case of the body stabilization switch 213b being in an OFF state, a lens stabilization is operated if the lens stabilization switch 108a is in an ON state. While, in the case of both the body stabilization switch 213b and lens stabilization switch 108a being in OFF states, a stabilization operation is not carried out.

Also in the case of a stabilization mode being the lens priority mode, lens stabilization is operated if the lens stabilization switch 108a is in an ON state, regardless of the body stabilization switch 213b being in an ON or OFF state during the first release through the prior to an exposure. And, if the lens stabilization switch 108a is in an OFF state, lens stabilization is not operated.

Comparably, during an exposure, a lens stabilization is operated if the lens stabilization switch 108a is in an ON state, regardless of the body stabilization switch 213b being in an ON or OFF state. In the case of lens stabilization switch 108a being in an OFF state, a body stabilization is operated if the body stabilization switch 213b is in an ON state. While, in the case of both the lens stabilization switch 108a and body stabilization switch 213b being in OFF states, no stabilization operation is carried out.

As described above, the use of control information, such as defocus amount and aperture value, necessary for controlling a photo lens 100 for controlling a stabilization operation of the aforementioned photo lens 100 brings forth a benefit of accomplishing a communication without complicating communications between the photo lens 100 and camera body 200.

And the use of control information, which is necessary for controlling the photo lens 100, for controlling a stabilization operation of the aforementioned photo lens 100 enables a control of the stabilization operation of the aforementioned photo lens 100 without adding a communication process anew. This results in bringing forth a benefit of preventing a delay in an operation start (i.e., a release time lag) caused by adding the new communication process, e.g., a time delay between an operation of the release switch 213a and an actual stabilization operation or an exposure starts.

Also, in the process of the camera system according to the present embodiment shown in FIGS. 18A through 18C, a lens stabilization operation is started upon detecting an ON state of the first release switch, and it is therefore possible to exclude an influence of a camera shake from an object image observed through the finder which is constituted by the penta prism 201b and eye piece lens 201c, for example. This brings forth a benefit of enabling a stable photographing (e.g., a framing).

### (3) Third Embodiment

FIG. 20 is a diagram showing an overall configuration of a camera system according to the third embodiment.

The camera system shown by FIG. 20 is constituted by a photo lens 100 and a camera body 500 which are mutually detachably connected to each other.

The photo lens 100 is one described in association with FIG. 1. The camera body 500 is one further comprising a control panel 501 for displaying various pieces of photography information and a finder display unit 502 for displaying photography information within a finder, in addition to the camera body 200 described in association with FIG. 1.

The control panel 501 displays not only displays relating to the stabilization functions (simply “stabilization display 506” hereinafter) of the photo lens 100 and camera body 500, but also photometry mode, AF mode, image quality mode, shutter speed, aperture value of a diaphragm, remaining battery power, the number of available imaging frames, color space setup, setup for rapid continuous shots, et cetera. Also, the finder display unit 502 and LCD monitor 212 display a stabilization display 506.

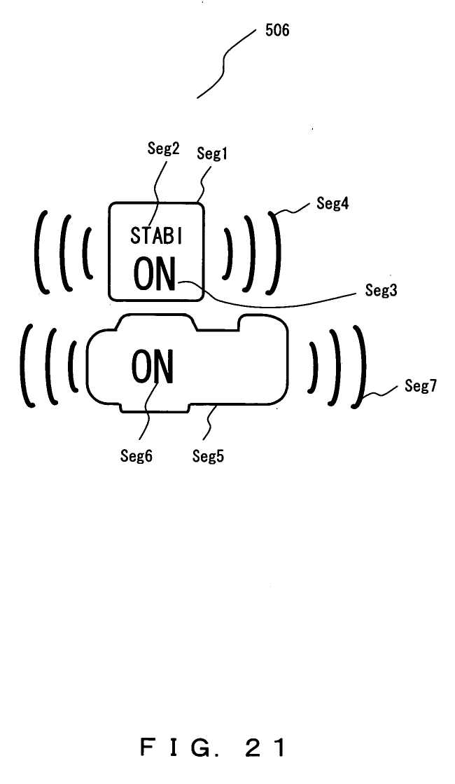

FIG. 21 is a diagram showing a concrete example of a stabilization display 506 according to the third embodiment.

The stabilization display 506 shown by FIG. 21 comprises a segment Seg1 for expressing a photo lens 100, a segment Seg2 for expressing the photo lens 100 comprising a stabilization function, a segment Seg3 for expressing a lens stabilization switch 108a of the photo lens 100 being in an ON state, a segment Seg4 for expressing a lens stabilization being in operation, a segment Seg5 for expressing a camera body 200, a segment Seg6 for expressing a body stabilization switch 213b of the camera body 200 being in an ON state and a segment Seg7 for expressing a body stabilization being in operation.

A display process of the above described stabilization display 506 is shown in FIG. 22 which is a flow chart showing a display process of the stabilization display 506.

When an attachment or a detachment of the photo lens 100 to or from the camera body 200, or operation on the lens operation switch 108 or camera operation switch 213 is performed for example, an interrupt signal according to the said operation is transmitted to the system controller 204 and the stabilization display data 220 stored in the Flash Rom 216 is updated using a prescribed program, followed by a display process based on the stabilization display data 220 being started (S2200).

Here, the stabilization display data 220 shown in FIG. 22 comprises an attachment state of the photo lens 100, stabilization response information indicating a presence or absence of a stabilization function of a mounted photo lens 100, lens stabilization switch information indicating an ON or OFF state of the lens stabilization switch 108a, lens stabilization operation information indicating an operation state (i.e., in operation or not) of a lens stabilization, body stabilization switch information indicating an ON or OFF state of the body stabilization switch 213b and body stabilization operation information indicating an operation state (i.e., in operation or not) of a body stabilization.

In the S2201, the system controller 204 for example reads the stabilization display data 220 from a prescribed address of the Flash Rom 216 and shifts the process to the S2202.

Note that a display target is the LCD monitor 212, control panel 501 or finder 502 in the following display process. And what is displayed is in the same format as the stabilization display 506 shown by FIG. 21 for displaying in either of the aforementioned display means.

The system controller 204 displays the Seg5 for indicating the camera body 500 in the LCD monitor 212, control panel 501 and finder 502, as appropriate, in the S2202.

The system controller 204 further displays a mounting state of the photo lens 100. It for example refers to the mounting information of the stabilization display data 220 and, if the photo lens 100 is in amounting state, displays the Seg1 for indicating the lens being mounted, while if it is not in a mounting state, turns off the display of the Seg1 (or, does not display it). The system controller 204 further refers to the stabilization response information of the stabilization display data 220 if the photo lens 100 is in the mounting state. And, if the photo lens 100 comprises a stabilization function, it displays the Seg2 for indicating the comprisal of the stabilization function, while if the photo lens 100 does not comprise a stabilization function, it turns off the display of the Seg2 (or, does not display it).

Having displayed the mounting state of the photo lens in the S2202, the system controller 204 shifts the process to the S2203 and displays the conditions of the lens stabilization switch 108a and body stabilization switch 213b.

For example, the system controller 204 refers to the lens stabilization switch information of the stabilization display data 220 and, if the switch is in an ON state, displays the Seg3, while, if the switch is not in an ON state (i.e., in an OFF state), turns off the Seg3 (or, does not display it).

Likewise, the system controller 204 refers to the body stabilization switch information of the stabilization display data 220 and, if the switch is in an ON state, displays the Seg6, while, if the switch is not in an ON state (i.e., in an OFF state), turns off the Seg6 (or, does not display it).

Upon completing the status display of stabilization switches in the S2203, the system controller 204 shifts the process to the S2204 and displays the status of the lens stabilization operation and body stabilization operation.

The system controller 204 for example refers to the lens stabilization operation information of the stabilization display data 220. If the lens stabilization is in operation, it displays the Seg4, while, if a lens stabilization is not in operation, it turns off the Seg4 (or, does not display it).

The system controller 204 further refers to the body stabilization operation information of the stabilization display data 220. If the body stabilization is in operation, it displays the Seg7, while, if a body stabilization is not in operation, it turns off the Seg7 (or, does not display it).

Upon completing the above described processes, the system controller 204 ends the display process (S2205).

The above description has shown the stabilization display process which is carried out in the case of the system controller 204 updating the content of the concerned stabilization display data 220 in response to an interrupt signal from the lens operation switch 108, et cetera. The process is the same in the case that the content of the aforementioned stabilization display data 220 has been updated by the processes of FIGS. 2, 3A, 3B and 5, for example.

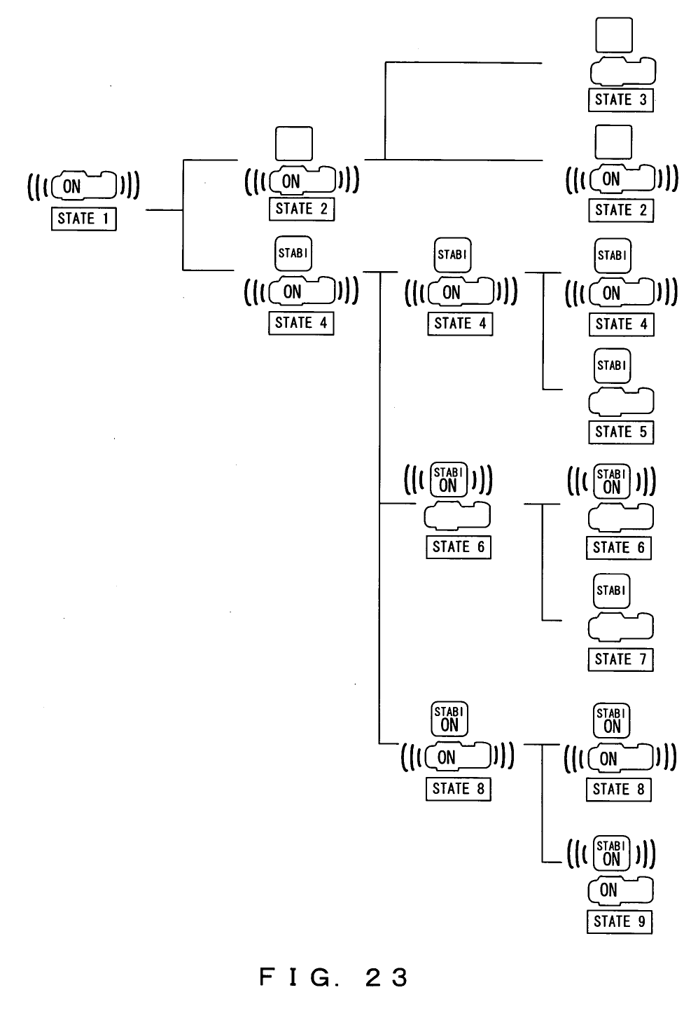

FIG. 23 exemplifies state transitions of a stabilization display 506 according to the third embodiment.

A state 1 is one displaying the Seg5 through Seg7. The display of the Seg6 informs an ON state of the body stabilization switch. And the display of the Seg7 informs the body stabilization being in operation. No display of the Seg1 indicates a photo lens being not yet mounted.

Mounting a photo lens comprising no stabilization function in the state of the state 1 displays the Seg1 as shown in a state 2. Then, making the body stabilization switch 213b an OFF state in the state of the state 2 turns off the displays of Seg6 and Seg7, and shifts the state to the state 3.

As a result, the state 2 indicates the state of the photo lens comprising no stabilization function being mounted, the body stabilization switch 213b being in an ON state and the stabilization function of the camera being in operation. A state 3 indicates the state of the photo lens comprising no stabilization function and a stabilization function of the camera being not in operation.

Meanwhile, mounting a photo lens comprising a stabilization function in the state of the state 1 displays the Seg2 as shown in a state 4 and makes a transition thereto. Further making the body stabilization switch 213b an OFF state in the state 4 turns off the displays of Seg6 and Seg7 and makes a transition to the state 5.

As a result, the state 4 indicates the state of a photo lens comprising a stabilization function being mounted, the body stabilization switch 213b being in an ON state and a stabilization function of the camera body being in operation. And a state 5 indicates the state of a photo lens comprising a stabilization function being mounted, and stabilization functions of the photo lens and camera body being not in operation.

Setting the body stabilization switch 213b to an OFF state and the lens stabilization switch 108a to an ON state in the state of the state 4 turns off the displays of the Seg6 and Seg7, turns on the displays of the Seg3 and Seg4, and makes a transition to a state 6. Furthermore, making the lens stabilization switch 108a an OFF state in the state of the state 6 turns off the displays of the Seg3 and Seg4 and makes a transition to a state 7.

As a result, the state 6 indicates the state of a photo lens comprising a stabilization function being mounted, the lens stabilization switch 108a being in an ON state and the stabilization function of the photo lens being in operation. And the state 7 indicates the state of a photo lens comprising a stabilization function being mounted and stabilization functions of the photo lens and camera body being not in operation.

Making the lens stabilization switch 108a an ON state in the state of the state 4 turns on the Seg3 and makes a transition to a state 8. In the case of the mode setup switch 213c being set up for the body priority mode in this event, the state 8 is retained. In the case of the mode setup switch 213c being set up for the lens priority mode, the display of the Seg7 is turned off, that of the Seg4 is turned on and a transition to a state 9 is made.

As a result, the state 8 indicates the state of a photo lens comprising a stabilization function being mounted, both the lens stabilization switch 108a and body stabilization switch 213b being in ON states and a stabilization function of the camera body being in operation. And the state 9 indicates the state of a photo lens comprising a stabilization function being mounted, both the lens stabilization switch 108a and body stabilization switch 213b being in ON states, and a stabilization function of the photo lens being in operation.

The following shows examples of displaying the above described stabilization display 506 in the LCD monitor 212, control panel 501 and finder 502.

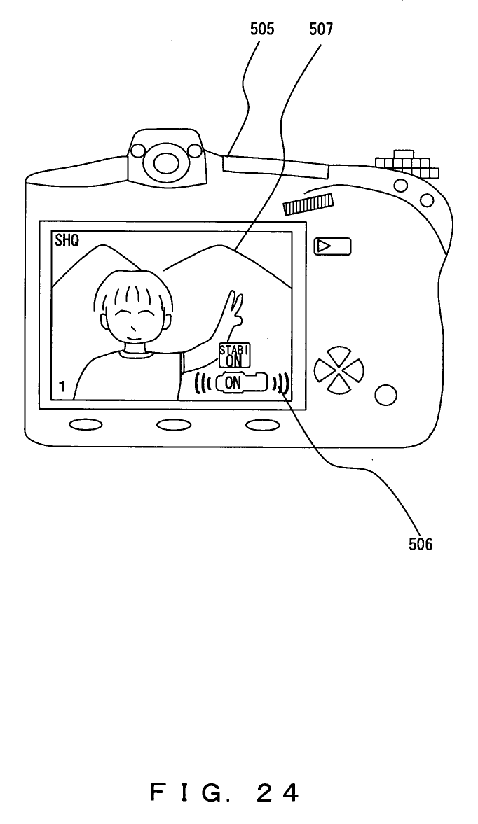

FIG. 24 is a diagram exemplifying the case of displaying, in the LCD monitor 212, a stabilization display 506. The LCD monitor 212 shown in FIG. 24 shows a rear display monitor equipped in the rear of a single lens reflex camera.

The displaying of FIG. 24 exemplifies a state of displaying a photographed image 507 by a replay button, also displaying a stabilization display 506 close to the right bottom corner of the LCD monitor 212. The stabilization display 506 informs that the image 507 in replay by the LCD monitor 212 has been photographed by using a stabilization function comprised by the camera body in lieu of using one comprised by the photo lens.

Note that the process for displaying the stabilization display 506 in the LCD monitor 212 is the same as the process shown in FIG. 22, except that the stabilization display data 220 uses the one corresponding to the image 507 stored in the header part of Exif data.

Incidentally, FIG. 24 exemplifies a display of a stabilization display 506 at the time of an image replay, it is, however, apparently possible to display a stabilization display 506 in the LCD monitor 212 by the process shown in FIG. 22 at the time of photographing.

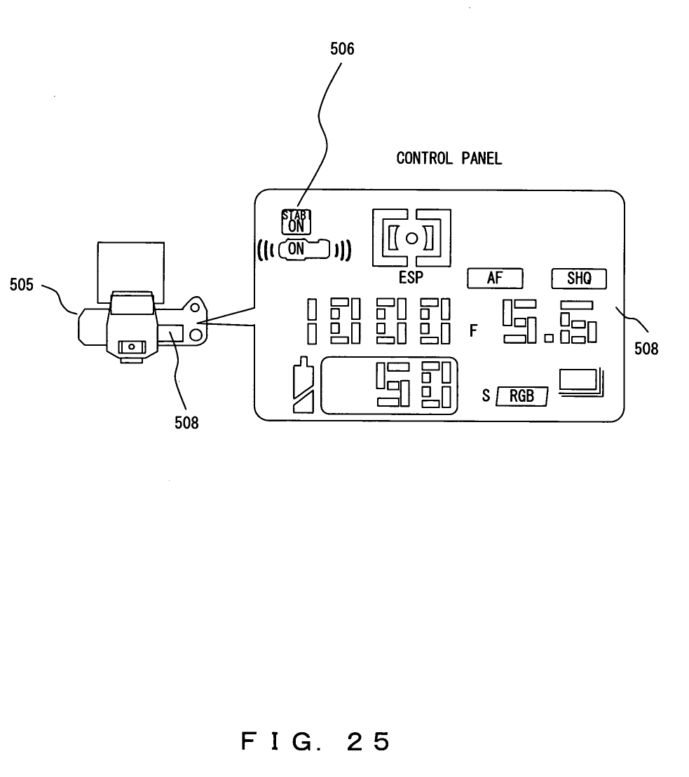

FIG. 25 is a diagram exemplifying the case of displaying, in a control panel 501, a stabilization display 506. The control panel 501 shown in FIG. 25 exemplifies an external display LCD 508 equipped in the top surface of a single lens reflex camera 505. The external display LCD 508 displays photometry mode, AF mode, image quality mode, shutter speed, aperture value of diaphragm, remaining battery power, the number of remaining for shooting, color space setup, quick continuous shots setting, et cetera, in addition to the stabilization display 506 displayed close to the left top corner.

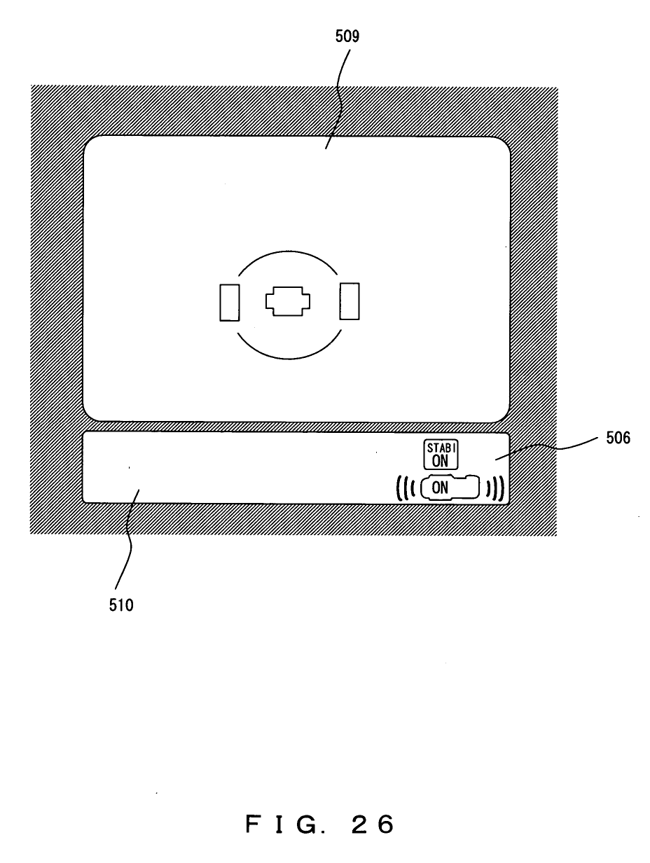

FIG. 26 is a diagram exemplifying the case of displaying, in a finder 502, a stabilization display 506.

The finder 502 shown by FIG. 26 comprises a view frame 509 for observing an object by way of the photo lens 100 and an optical system of the camera body 500; and an LCD display part 510 for displaying a shutter speed, an exposure, et cetera. And a stabilization display 506 is shown at the right corner of the LCD display part 510.

As described above, the present embodiment is configured to enable a provision of a camera system capable of controlling a stabilization function comprised by the photo lens 100 without complicating communications between the photo lens 100 and camera body 200. And the camera system according to the present embodiment is configured to display the segment Seg4 or segment Seg7 in the LCD monitor 212, control panel 501 and finder 502 according to the lens stabilization operation information and body stabilization operation information in the stabilization display data 220, thereby bringing forth the benefit of enabling a user to easily recognize as to which of the stabilization functions respectively comprised by the photo lens 100 and the camera body 200 is in operation.

Also configured is to display the segment Seg3 and segment Seg6 in the LCD monitor 212, control panel 501 and finder 502 according to the lens stabilization switch information and body stabilization switch information in the stabilization display data 220, thereby bringing forth the benefit of enabling the user to easily recognize a setting of a stabilization function (i.e., being enabled or disabled) comprised by the photo lens 100 and the one comprised by the camera body.

Also configured is to display the segment Seg1 and segment Seg2 in the LCD monitor 212, control panel 501 and finder 502 according to the mounting information and stabilization response information in the stabilization display data 220, thereby bringing forth the benefit of enabling the user to easily recognize as to whether or not the photo lens 100 is mounted to the camera body 500 and whether or not the mounted photo lens 100 comprises the stabilization function.

What is claimed is:

1. A interchangeable camera system which connects a photography lens to a camera body in a mutually detachably attachable manner, comprising:
a transmission circuit comprised by the camera body and which is a circuit for transmitting control information used for controlling the photography lens from the camera body thereto;
a reception circuit comprised by the photography lens and which is a circuit for receiving the control information transmitted from the transmission circuit;
a camera shake correction unit which is comprised by the photography lens and which is the unit for correcting a shake generated in a image on a photographed surface by a shake of the camera system at the time of photographing; and
a camera shake correction control unit for changing an operation condition of the camera shake correction unit when the reception circuit receives prescribed control information for issuing a setup instruction for a photographing preparation.

2. The camera system according to claim 1, wherein
said prescribed control information is movement information for controlling a movement amount of a focus lens comprised by the photography lens.

3. The camera system according to claim 2, wherein
said movement information includes the case of a movement amount of said focus lens being zero (“0”).

4. The camera system according to claim 1, wherein
said prescribed control information is diaphragm setup information for controlling an aperture value of a diaphragm comprised by said photography lens.

5. The camera system according to claim 4, wherein
said diaphragm setup information includes the case of said aperture value of said diaphragm being zero (“0”).

6. The camera system according to claim 1, wherein
said camera-shake correction control unit makes said camera-shake correction unit operate when said reception circuit receives said prescribed control information.

7. The camera system according to claim 1, wherein
said camera shake correction control unit makes said camera shake correction unit stop operating when said reception circuit receives said prescribed control information.

8. The camera system according to claim 1, wherein
said camera shake correction control unit makes said camera shake correction unit stop operating and move a correction lens comprised thereby to a predefined position.

9. The camera system according to claim 1, wherein
said camera shake correction control unit makes said camera shake correction unit operate if said prescribed control information is movement information for a focus lens comprised by said photography lens, while makes the camera shake correction unit stop operating if the prescribed control information is diaphragm setup information for a diaphragm comprised by the photography lens.

10. The camera system according to claim 1, wherein
said camera shake correction control unit makes said camera shake correction unit operate if said prescribed control information is movement information for a focus lens comprised by said photography lens, while makes a correction lens comprised by the camera shake correction unit move to a predefined position if the prescribed control information is diaphragm setup information for a diaphragm comprised by the photography lens.

11. The camera system according to claim 1, wherein
said transmission circuit generates and transmits said prescribed control information according to a photography preparation operation start instruction.

12. The camera system according to claim 1, wherein
said transmission circuit generates and transmits said prescribed control information according to a photography operation start instruction.
